(19) United States
(12) Patent Application Publication
(10) Pub. No.: US 2016/0209907 A1
(43) Pub. Date: Jul. 21, 2016

(54) METHOD FOR PERFORMING POWER-SAVING MODE IN ELECTRONIC DEVICE AND ELECTRONIC DEVICE THEREFOR

(71) Applicant: SAMSUNG ELECTRONICS CO., LTD., Gyeonggi-do (KR)

(72) Inventors: Kyu-Jin HAN, Gyeonggi-do (KR); Tae-Yun KIM, Gyeonggi-do (KR); Min-Sung EO, Gyeonggi-do (KR); Sang-Hyeon YOON, Gyeonggi-do (KR); Young-Je LEE, Gyeonggi-do (KR)

(21) Appl. No.: 14/913,599

(22) PCT Filed: Aug. 22, 2014
(86) PCT No.: PCT/KR2014/007828

§ 371 Date: Feb. 22, 2016

(30) Foreign Application Priority Data
Aug. 22, 2013 (KR) 10-2013-0099809
Sep. 23, 2013 (KR) 10-2013-0112905
Feb. 21, 2014 (KR) 10-2014-0020967

(51) Int. Cl. G06F 1/32

(52) U.S. Cl. CPC G06F 1/3209

(57) ABSTRACT

A method of and an electronic device for performing a power-saving mode in the electronic device, according is provided. The method includes driving at least one processor; detecting a command for switching to a power-saving mode; and if the command for switching to the power saving mode is detected, limiting operations of the at least one processor to block set functions other than a power saving call function in accordance with at least one set power saving scheme.

### PRIORITY

This application is a National Phase Entry of PCT International Application No. PCT/KR2014/007828, which was filed Aug. 22, 2014, and claims priority to a Korean Patent Application filed on Aug. 22, 2013 in the Korean Intellectual Property Office and assigned Serial No. 10-2013-0099809, a Korean Patent Application filed on Sep. 23, 2013 in the Korean Intellectual Property Office and assigned Serial No. 10-2013-0112905, and a Korean Patent Application filed on Feb. 21, 2014 in the Korean Intellectual Property Office and assigned Serial No. 10-2014-0020967, the entire contents of each of which are incorporated herein by reference.

### BACKGROUND

1. Field of the Disclosure

The present disclosure relates generally to a method of performing a power saving mode in an electronic device, and an electronic device for the same.

2. Description of the Related Art

A basic requirement for using an electronic device is a guarantee that a battery may be used for a long time. In general, an electronic device uses a rechargeable battery as a power supply source and a maximum use time thereof is determined based on a single charge according to a charging capacity of the rechargeable battery. However, if it is required to frequently replace the battery due to large current consumption in order to use an electronic device having various functions, it may be a great limitation on the use of the electronic device.

Accordingly, there is a method of increasing a use time through the development of technologies of the battery to increase the charging capacity of the battery. However, the method of increasing the charging capacity of the battery has a physical limit.

A usable time of the electronic device is determined according to the charging capacity of the battery included in the electronic device. Accordingly, a user must rely on a limited battery power to use an electronic device.

Further, as the supply of smart phones has recently increased, a user of a smart phone may use various applications such as photos, music, videos, multimedia, games, and the like as well as a basic call function. However, a smart phone consumes a relatively large amount of power due to the execution of applications. Accordingly, a user may frequently not be able to use a smart phone if the battery power is less than or equal to the battery capacity necessary for the operation of the smart phone if the user does not check a residual capacity of the battery. Further, due to a lack of residual capacity of a battery, a call is frequently disconnected.

### SUMMARY

According to an aspect of the present disclosure, a method of and an apparatus for minimizing power consumption in a power saving mode are provided.

According to another aspect embodiment of the present disclosure a method of and an apparatus are provided for limiting at least one functions provided by an electronic device to reduce power consumption.

According to another aspect of the present disclosure a method of and an apparatus are provided for minimizing power consumption by limiting the use of functions except for a basic call-related function of an electronic device or an application which is released from the use limit by a user in a power saving mode.

According to another aspect of the present disclosure a method of and an apparatus are provided for minimizing power consumption by limiting periodic communication with a network in a power saving mode.

An aspect of the present disclosure maximizes a driving time of an electronic device by switching to a power saving mode in which battery consumption may be minimized.

An aspect of the present disclosure minimizes power consumption by controlling functions that consume large amounts of power except for a basic call-related function if an electronic device such as a smart phone cannot charge a battery in an emergency situation.

An aspect of the present disclosure reduces power consumption by limiting functions except for a basic call-related function of an electronic device or an application which is released from a use limit by a user as the electronic device enters a power saving mode.

An aspect of the present disclosure reduces power consumption by limiting reception/transmission of communication data through periodic communication with a network in a screen off state.

An aspect of the present disclosure maximizes a driving time of an electronic device by switching to a power saving mode in which battery consumption of the electronic device (for example, a smart phone or the like) may be minimized if an emergency disaster situation occurs.

An aspect of the present disclosure significantly increases a time in which external contact is possible in a dangerous situation by minimizing battery consumption of an electronic device if an emergency disaster situation occurs, thereby significantly increasing a chance of rescue and survival.

In accordance with an aspect of the present disclosure, a method of performing a power saving mode in an electronic device is provided. The method includes driving at least one processor; detecting a command for switching to a power saving mode; and if the command for switching to the power saving mode is detected, limiting operations of the at least one processor to block set functions other than a power saving call function in accordance with at least one set power saving scheme.

In accordance with another aspect of the present disclosure, an electronic device for performing a power saving mode is provided. The electronic device includes a display unit configured to display a power saving screen if a command for switching to a power saving mode is detected, wherein the display unit is functionally connected to the electronic device; and a control unit including a call processor (CP) configured to control a power saving call-related function and an application processor (AP) configured to control other functions except for the power saving call-related function, wherein the control unit is configured to limit an operation of at least one of the CP and the AP to block at least some of the other functions in accordance with at least one set power saving schemes if the command for switching to the power saving mode is detected.

### BRIEF DESCRIPTION OF THE DRAWINGS

The foregoing and other aspects, features, and advantages of the present invention will be more apparent from the following description, taken in conjunction with the accompanying drawings, in which:

FIG. 1 is a block diagram of an electronic device according to an embodiment of the present disclosure;

FIG. 2 is a front perspective view of an electronic device according to an embodiment of the present disclosure;

FIG. 3 is a block diagram of a power saving mode processing device according to an embodiment of the present disclosure;

FIG. 4 is a flowchart of a method of switching to a power saving mode of an electronic device according to an embodiment of the present disclosure;

FIG. 5 is a flowchart of a method of a power saving mode based on a network power saving scheme according to an embodiment of the present disclosure;

FIGS. 6A to 9B are block diagrams of network signal processing between a normal mode and a power saving mode according to embodiments of the present disclosure;

FIG. 10 is a flowchart of a method of a power saving mode based on a power saving scheme according to an embodiment of the present disclosure;

FIGS. 11A and 11B illustrate current consumption in an electronic device according to a power off/on state in each of a normal mode and a power saving mode according to an embodiment of the present disclosure;

FIG. 12 is a flowchart of a method of a power saving mode based on an application limiting power saving scheme according to an embodiment of the present disclosure;

FIG. 13A illustrates an electronic device changing a home screen configuration according to a setting of a power saving mode according to an embodiment of the present disclosure;

FIG. 13B illustrates a screen of a home screen in an emergency mode of an electronic device according to an embodiment of the present disclosure;

FIG. 13C illustrates a screen describing a power saving mode setting scheme in an electronic device according to an embodiment of the present disclosure;

FIG. 14 is a flowchart of a method of a power saving mode based on a screen power saving scheme according to an embodiment of the present disclosure;

FIG. 15 illustrates changing a display unit screen of an electronic device to black and white according to an embodiment of the present disclosure;

FIG. 16 is a block diagram of an emergency disaster message transmission system according to an embodiment of the present disclosure;

FIG. 17 is a block diagram of an electronic device according to an embodiment of the present disclosure;

FIG. 18 is a flowchart of a method of a mode switching process by an emergency disaster message according to an embodiment of the present disclosure;

FIG. 19 is a flowchart of a method of an emergency mode switching process according to an embodiment of the present disclosure;

FIG. 20 is a flowchart of a method of an emergency mode switching process according to an embodiment of the present disclosure;

FIG. 21 is a flowchart of a method of an emergency mode switching process according to an embodiment of the present disclosure;

FIG. 22 is a flowchart of a method of a setting process performed if switching to an emergency mode according to an embodiment of the present disclosure;

FIG. 23 is a block diagram of an electronic device according to an embodiment of the present disclosure;

FIG. 24 illustrates layers for processing a received emergency disaster message according to an embodiment of the present disclosure;

FIG. 25A illustrates a screen configuration for setting an emergency situation in an electronic device according to an embodiment of the present disclosure;

FIG. 25B illustrates a screen configuration of an emergency mode switching window in an electronic device according to an embodiment of the present disclosure;

FIG. 26 illustrates a screen configuration based on a setting of an emergency situation in an electronic device according to an embodiment of the present disclosure;

FIG. 27 illustrates an example where an electronic device changes a home screen configuration according to an emergency mode setting according to an embodiment of the present disclosure; and

FIGS. 28A to 28C illustrate a deactivated application according to an emergency mode setting in the electronic device according to an embodiment of the present disclosure.

### DETAILED DESCRIPTION OF EMBODIMENTS OF THE PRESENT DISCLOSURE

Embodiments of the present disclosure are described below more fully with reference to the accompanying drawings, but the present disclosure may include various changes and modifications, and may have various embodiments. However, it should be understood that there is no intent to limit the present disclosure to the particular forms disclosed, but on the contrary, the present disclosure is intended to cover all modifications, equivalents, and/or alternatives falling within the scope and spirit of the present disclosure.

The terms used in the present disclosure are for the purpose of describing certain embodiments only and are not intended to be limiting of the present disclosure. Singular forms are intended to include plural forms unless the context clearly indicates otherwise. In the present disclosure, the terms such as “include” or “have” may be construed to denote a certain characteristic, number, step, operation, constituent element, component or a combination thereof, but are not intended to be construed to exclude the existence of or a possibility of addition of one or more other characteristics, numbers, steps, operations, constituent elements, components or combinations thereof.

Unless defined otherwise, all terms used herein have the same meanings as those commonly understood by those skilled in the art. Such terms as those defined in a generally used dictionary are to be interpreted to have the same meanings as the contextual meanings in the relevant field of the art, and are not intended to be interpreted to have ideal or excessively formal meanings unless clearly defined in the present disclosure.

In an embodiment of the present disclosure, an electronic device may be any device having a touch screen and may be referred to as a portable terminal, a mobile terminal, a communication terminal, a portable communication terminal, a portable mobile terminal or the like. For example, an electronic device may be a smartphone, a mobile phone, a game machine, a television (TV), a display device, a head unit for a vehicle, a notebook computer, a laptop computer, a tablet computer, a personal media player (PMP), a personal digital assistant (PDA), a navigation device, an automated teller machine (ATM) of a bank, a point of sale (POS) device of a shop, an Internet of Things (IoT) device, and the like. Further, in the present disclosure, an electronic device may be a flexible device or a flexible display device.

A representative configuration of an electronic device corresponds to a configuration of a mobile phone, where some components of the representative configuration of the electronic device may be omitted or changed as necessary.

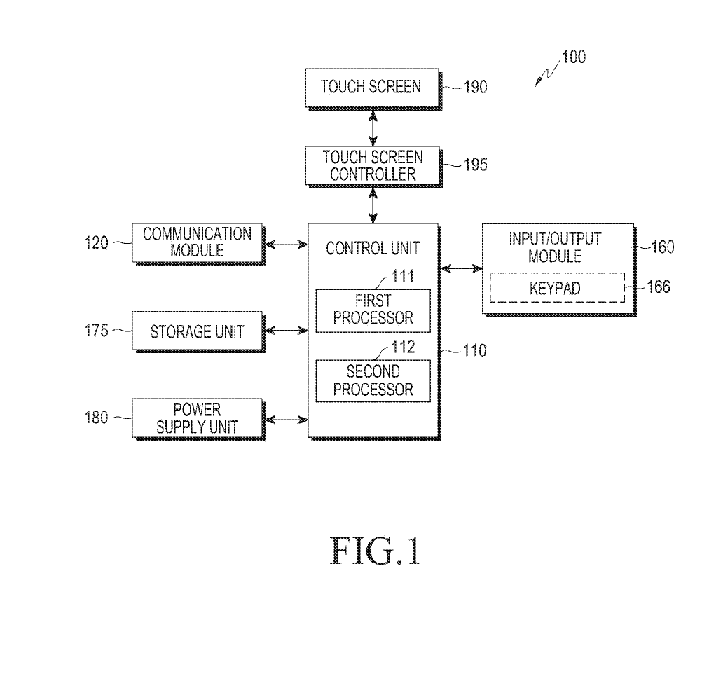

FIG. 1 is a block diagram of an electronic device 100 according to an embodiment of the present disclosure.

Referring to FIG. 1, the electronic device 100 includes at least one touch screen 190 and at least one touch screen controller 195. In an embodiment of the present disclosure, the touch screen 190 and the touch screen controller 195 are a display unit and a display controller, respectively. Further, the electronic device 100 may include a control unit 110, a communication module 120, an input/output module 160, a storage unit 175, and a power supply unit 180.

The control unit 110 may include a bus for information communication and at least one processor connected to the bus for information processing. Further, a second memory (for example, random access memory (RAM) connected to the bus to store information required by the at least one processor may be included. The second memory may be used for storing temporary information required by the at least one processor. The electronic device 100 may further include a read only memory (ROM) connected to the bus to store static information required by the at least one processor.

The control unit 110 may control overall operations of the electronic device 100 as a central processing unit (CPU) and to perform an operation based on a method of performing a power saving mode according to an embodiment of the present disclosure. The control unit 110 according to an embodiment of the present disclosure may limit the performance of the CPU in the power saving mode. To this end, the control unit 110 may change a CPU clock speed to operate in the power saving mode. For example, a clock speed of 1.6 GHz in the normal mode may be reduced to a clock speed of 1.2 GHz in the power saving mode. In general, as clock speed increases, processing speed increases, and current consumption increases. Accordingly, in the power saving mode, the current consumption may be reduced by reducing the clock speed. Further, in another example of a method of limiting CPU performance, the control unit 110 may be changed to operate with a single core. For example, if the control unit 110 switches to the power saving mode while operating with eight cores, the control unit 110 may limit the performance by using at least one core. As described above, by limiting the CPU performance, the current consumption may be reduced.

To this end, the control unit 110 according to an embodiment of the present disclosure may include at least one processor. According to an embodiment of the present disclosure, although one processor includes a first processor 111 and a second processor 112 as an example illustrated in FIG. 1, the first processor 111 or the second processor 112 may be implemented as one integrated processor. The first processor 111 may be a CP that controls the overall operations of the electronic device 100 and the second processor 112 may be an AP that supports multimedia.

The first processor 111 may perform a function related to a power saving call in which basic communication such as message transmission/reception is possible, and the second processor 112 may serve to perform a multimedia function to smoothly execute and control various additional functions such as a camera function, a multimedia data reproduction function, and the like.

The control unit 110 according to an embodiment of the present disclosure may drive both the first processor 111 and the second processor 112 in the normal mode and control an operation for executing various applications under an operating system. If a power saving mode switching condition is meet, the control unit 110 may block the driving of at least one of the first processor 111 and the second processor 112 or limit at least one operation in accordance with a power saving scheme to operate in the power saving mode in which access to some functions of the electronic device 100 is restricted.

For example, a function to which access is restricted may be controlled to not be displayed in a power saving screen or, even if a user input such as a touch input is generated for the function of which the access is restricted, may be controlled to not execute any operation. Alternatively, the control unit 110 may disable all applications or services including applications executed in the background except for at least one application, which is allowed in the power saving mode. In this case, a list of the applications, which are allowed in the power saving mode, may include a power saving call function set by default and a user may add/delete applications through a setting menu.

According to an embodiment of the present disclosure, a power saving screen may be configured using at least one of a control of brightness of a screen of a display unit, switching of a mode of the screen of the display unit to a gray mode, switching of a home screen of the display unit to a home screen of a minimum function, and deactivation of other applications except for configured necessary applications. If a command for switching to the power saving mode is detected, the power saving screen may be displayed on a display unit functionally connected to the electronic device 100.

According to an embodiment of the present disclosure, the control unit 110 may store information on power saving items of which the use will be omitted, to limit the use of functions related to battery consumption in the power saving mode. For example, in the power saving mode, the electronic device 100 may limit the remaining functions except for minimum functions necessary for the electronic device 100 to minimize power consumption. For example, the electronic device 100 may switch other functions except for only a power saving call function related to message reception to a disabled state. Further, the electronic device 100 may switch a screen displayed through the touch screen 190 to the power saving mode in which minimum power is consumed.

According to an embodiment of the present disclosure, entry into the power saving mode may be divided into a manual type or an automatic type.

For example, in the automatic type, if an emergency message described below is received, the mode may be switched to the power saving mode according to the content contained in the received emergency message. Further, in the automatic type, if a residual amount of the battery is less than or equal to a predetermined level, the mode is switched to the power saving mode according to a power saving mode switching condition such as a predetermined place. Accordingly, the control unit 110 may check the power saving mode switching condition and, if the condition is met, automatically switch to the power saving mode. In contrast, if the condition is not met in the automatic type since charging is re-initiated in the power saving mode or a user leaves a place, the mode may be automatically switched to the normal mode.

According to an embodiment of the present disclosure, the emergency message which may be received by the electronic device 100 may include any type of emergency message. For example, if a user is in an emergency situation such as distress, kidnapping, or the like, the user cannot deal with the emergency situation by him/her self. Accordingly, in this case, it is required to switch the mode to an emergency mode by a designated user such as a family member or the like. To this end, according to an embodiment of the present disclosure, there is a method of designating a user who may transmit the emergency message to the electronic device 100 of the user and switching the mode of the electronic device 100 to the emergency mode by the designated user. As described above, if the emergency situation is registered by the designated user through, for example, a find my mobile (FMM) server or the like, the FMM server may transmit the emergency message to the electronic device 100. The emergency message from the FMM server may be used to find the user who is in the emergency situation through making inquiries about the location of the electronic device 100 of the user.

Further, according to an embodiment of the present disclosure, the emergency message may be a message provided from a predetermined service server that provides emergency information. For example, if an emergency disaster situation (for example, a typhoon, a tsunami, an earthquake or the like) occurs, the emergency disaster message may be a message provided by a cell broadcast message service (CBS), an earthquake and tsunami warning service (ETWS) or the like, which provides emergency disaster information, but the present disclosure is not limited thereto.

According to an embodiment of the present disclosure, in the manual type, the mode may be switched to the power saving mode through a setting change window for the mode switching. In addition, the mode may be switched by pressing a power key of a keypad 166 for a predetermined (e.g. long) time, or through a button arranged on a status bar for displaying a status of the electronic device 100, a setting menu, or the like.

As described above, according to an embodiment of the present disclosure, it is possible to maximize a driving time of the electronic device 100 by controlling power saving items such as functions except for the function related to data from/to the network, the display unit, and the phone call.

Further, according to an embodiment of the present disclosure, the power saving may be controlled in stages and, accordingly, limited operations may vary depending on each power saving stage. For example, if a user desires to execute the power saving mode and thus perform triggering, the user may control the power saving stages through the setting menu. The power saving stages may include two or more stages and operations corresponding to the stages may be defined as follows.

For example, a first power saving stage may correspond to a basic power saving mode that is basically implemented in the electronic device 100. A second power saving mode may further define an operation of limiting screen brightness and display the screen in black and white in addition to the limited operations corresponding to the basic power saving mode.

A third power saving mode may define an operation of limiting data exchanged in the background in addition to the limited operations of the second power saving mode, which may be referred to as an ultra power saving mode.

A fourth power saving mode may define an operation of limiting a resolution to 50% of its highest possible resolution and an operation of limiting a touch area to 50% of its area in addition to the limited operations of the third power saving mode. In this case, if the resolution is reduced to 50% of its highest possible resolution, the size of a screen area displayed on the touch screen 190 is reduced to half its area, and the remaining area may be in black and white. For example, rather than an entire screen area occupying the whole touch screen 190, only some of the screen area may be displayed on the touch screen 190. Some of the screen area may be disposed at the center of the touch screen 190, but the location thereof is not limited thereto. Accordingly, an area which the user may touch may be limited to a portion of the screen area. In this case, the electronic device 100 need only process the touch area at 50% of the highest possible resolution, so that the AP 320 consumes less current. Although it has been described that the power saving modes include the first to fourth modes as an example, the present disclosure is not limited thereto.

According to an embodiment of the present disclosure, the communication module 120 may be directly connected to an external device or connected through a network, where the connection may be by a wired or a wireless communication unit. The communication module 120 may transmit data from the control unit 110, the storage unit 175, or the like through a wire or wirelessly, or receive data through a wire or through the air wirelessly and transfer the data to the control unit 110 or store the data in the storage unit 175. The communication module 120 may include at least one of a mobile communication module, a wireless local area network (WLAN) module, and a short range communication module.

According to an embodiment of the present disclosure, the control unit 110 may communicate with an external device through the communication module 120 or perform a task through interworking with the external device. For example, the control unit 110 may receive an emergency disaster message from an emergency information providing server through the communication module 120, analyze the content contained in the emergency disaster message, and switch to a power saving mode.

The input/output module 160 may include at least one of a plurality of buttons, a microphone, a speaker, and a connector as well as the keypad 166. If the mode is switched to the power saving mode, a vibration output by a vibration device consumes more power than an output signal through a speaker. Thus, a ringtone of low power may be used in the power saving mode according to an embodiment of the present disclosure. For example, the electronic device 100 may enter a state for low power consumption by reducing a vibration pattern or changing the vibration to the ringtone if the electronic device 100 is in a vibration mode, or by reducing a volume of the ringtone or making the volume silent in a ringtone mode. Alternatively, the electronic device 100 may produce only a light emitting diode (LED) flash.

According to an embodiment of the present disclosure, the keypad 166 may receive a key input from the user to control the electronic device 100 or switch to the power saving mode. The keypad 166 includes a physical keypad formed in the electronic device 100 or a virtual keypad displayed on the touch screen 190. The physical keypad formed in the electronic device 100 may be excluded according to the performance or a structure of the electronic device 100.

According to an embodiment of the present disclosure, the storage unit 175 may store a signal or data input/output according to an operation of the communication module 120, the input/output module 160, or the touch screen 190 under control of the control unit 110. The storage unit 175 may store a control program for controlling the electronic device 100 or the control unit 110 and applications, and may also store information on a set power saving mode condition and information on power saving items of which use is limited in the power saving mode except for the basic phone call-related function (for example, a call, a message, or the like) according to an embodiment of the present disclosure.

The term “storage unit” may refer to a predetermined data storing device such as the storage unit 175, a ROM within the control unit 110, a RAM or a memory card (for example, a secure digital (SD) memory card, a memory stick or the like) inserted into the electronic device 100. The storage unit 175 may also include a non-volatile memory, a volatile memory, a hard disk drive (HDD), or a solid state drive (SSD).

Further, the storage unit 175 may store applications of various functions, images for providing a graphical user interface (GUI) related to the applications, databases or data related to a method of processing user information, a document, a touch input, background images (e.g., a menu screen, a standby screen, or the like), operating programs required for driving the electronic device 100, and images photographed by a camera module.

The storage unit 175 is a machine-readable medium (for example, a computer-readable medium), and the term “machine-readable medium” may refer to a medium that provides data to a machine so that the machine performs a certain function. The storage unit 175 may include a non-volatile medium and a volatile medium. All of these media may be tangible such that commands transferred by the media may be detected by a physical instrument such as a machine reading the commands.

The machine-readable medium includes at least one of a floppy disk, a flexible disk, a hard disk, a magnetic tape, a compact disc ROM (CD-ROM), an optical disk, a punch card, a paper tape, a RAM, a programmable ROM (PROM), an erasable PROM (EPROM), and a flash-EPROM, but the present disclosure is not limited thereto.

The power supply unit 180 may supply power to at least one arranged in a housing of the electronic device 100 according to a control of the control unit 110. The at least one battery supplies power to the electronic device 100. Further, the power supply unit 180 may supply power input from an external power source through a wired cable connected to a connector of the electronic device 100. In addition, the power supply unit 180 may supply power wirelessly input from an external power source through a wireless charging technology to the electronic device 100.

The electronic device 100 may include at least one touch screen 190 that provides graphical user interfaces corresponding to various services (for example, a phone call, data transmission, broadcasting, and photography) to a user.

The touch screen 190 may include a display panel that performs a display function for information output from the electronic device 100 and an input panel that performs various input functions selected by a user. The display panel may be a panel such as a liquid crystal display (LCD), an active-matrix organic LED (AMOLED) display, or the like.

The display panel may display various screens according to various operation statuses of the electronic device 100, application execution, services, and the like. Further, according to an embodiment of the present disclosure, the brightness of display panel may be set to a minimum in the power saving mode, and may display other functions except for a power saving call-related function as being in a deactivated state. Alternatively, the display panel may display a power saving screen in which functions except for the power saving call-related function are hidden.

The input panel may be implemented by one or more panels that may detect various inputs such as a single or a multi touch input of a user, a drag input, a writing input, a drawing input, and the like using various objects including a pen and the like. For example, the input panel may be implemented using one panel that may detect both a finger input and a pen input or may be implemented using two panels including a touch recognition module that may detect a finger input and a pen recognition module that may detect a pen input. According to an embodiment of the present disclosure, a touch booster used for improving touch sensitivity may be disabled in the power saving mode. In the power saving mode, in addition to the touch booster, the use of a booster for detecting a scroll, a rotation, and the like or at least one booster used for improving performance may be limited. As described above, by limiting the use of boosters, current consumption may be reduced.

The touch screen 190 may output a signal corresponding to at least one user input which is input to the graphical user interface to the touch screen controller 195. The touch screen 190 may receive at least one user input through a user's body (for example, fingers). The touch screen 190 may receive successive motions of one touch. The touch screen 190 may output an analog signal corresponding to successive motions of a touch input to the touch screen controller 195.

According to an embodiment of the present disclosure, the touch is not limited to a contact between the touch screen 190 and a user input means such as a finger or the like and may include a non-contact hover (for example, a case where the user input means is located within a recognition distance (for example, 1 cm) in which the user input means may be detected without directly contacting the touch screen 190). The distance or interval in which the screen 190 may recognize a user input means may be changed according to performance or structure of the electronic device 100. The screen 190 may be configured to output different values (for example, including a voltage value or a current value such as an analog value) detected by a direct touch event or a hovering event so that the direct touch event by contact with the user input means and an indirect touch event (that is, a hovering event) may be distinguished from each other.

The touch screen 190 may be implemented in, for example, a capacitive type touch screen, an infrared type touch screen, an acoustic wave type touch screen, or a combination thereof.

The touch screen controller 195 converts a signal input from the touch screen 190 to a digital signal and transmits the converted digital signal to the control unit 110. The control unit 110 may control a user interface displayed on the touch screen 190 by using a digital signal received from the touch screen controller 195. For example, the control unit 110 allows a short-cut icon or an object displayed on the touch screen 190 to be selected or executed in response to a direct touch event or a hovering event. Further, the control unit 110 may switch to the power saving mode in response to a touch event. The touch screen controller 195 may be integrated into the control unit 110.

The touch screen controller 195 may identify a hovering interval or distance as well as a location of the user input by detecting a value (for example, a current value or the like) output through the touch screen 190, convert the identified distance value to a digital signal (for example, a z-axis coordinate), and provide the converted digital signal to the control unit 110. Further, the control unit 110 may detect various user inputs received through the input/output module 160 as well as the touch screen 190. A user input may include various types of information input into the device 100, such as a gesture, a voice, a pupil action, and a biometric signal of a user as well as a touch. The control unit 110 may control the performance of a predetermined operation or function corresponding to the detected user input. For example, the control unit 110 may switch to the power saving mode or the normal mode in accordance with a user input and change a setting in the power saving mode.

Further, according to an embodiment of the present disclosure, each function unit and module may refer to a functional or structural combination of hardware for realizing the technical idea of the present disclosure and software for driving the hardware. For example, each function unit may refer to a logical unit of a predetermined code or a hardware resource for executing the predetermine code, and it may be easily inferred by those skilled in the art that the function unit does not necessarily refer to a physically connected code or one type hardware.

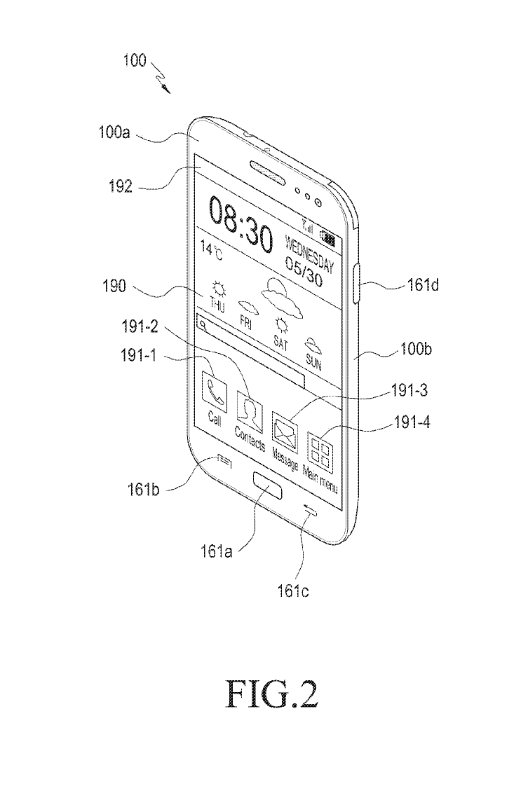

FIG. 2 is a front perspective view of the electronic device 100 according to an embodiment of the present disclosure.

Referring to FIG. 2, the touch screen 190 corresponding to an example of the display unit may be disposed at the center of a front surface 100a of the electronic device 100. The touch screen 190 may be large enough to occupy most of the front surface 100a of the electronic device 100. FIG. 2 illustrates an example where a main home screen is displayed on the touch screen 190. The main home screen is a first screen displayed on the touch screen 190 if power to the electronic device 100 is turned on. If the electronic device 100 has different home screens of a plurality of pages, the main home screen may be the first home screen among the home screens of the plurality of pages. Short-cut icons 191-1, 191-2, and 191-3 for executing frequently used applications, a main menu switching key 191-4, time, weather and the like may be displayed on the home screen. If the user selects the main menu switching key 191-4, the menu screen is displayed on the touch screen 190. Further, a status bar 192 which displays the status of the electronic device 100 such as a battery charging status, a received signal intensity, and a current time may be formed on an upper part of the touch screen 190. According to an embodiment of the present disclosure, an icon indicating the power saving mode may be displayed on the status bar 192. If the power saving mode switching condition is met, the icon may be activated and displayed.

A home button 161a, a menu button 161b, and a back button 161c may be formed below the touch screen 190. The home button 161a displays the main home screen on the touch screen 190. For example, if the home button 161a is selected in a state where a home screen different from the main home screen or a menu screen is displayed on the touch screen 190, the main home screen may be displayed on the touch screen 190. Further, if the home button 161a is selected while applications are executed on the touch screen 190, the main home screen may be displayed on the touch screen 190.

In addition, the home button 161a may be used to display recently used applications or a task manager on the touch screen 190.

The menu button 161b provides a connection menu which may be displayed on the touch screen 190. The connection menu may include a widget addition menu, a background image changing menu, a search menu, an editing menu, an environment setup menu and the like.

The back button 161c may be used to display the screen which was executed just before the currently executed screen or to terminate the most recently used application.

A power/lock button 161d, volume buttons including a volume increase button and a volume decrease button, or one or a plurality of microphones may be arranged at a side surface 100b of the electronic device 100.

According to an embodiment of the present disclosure, if an emergency disaster message is received or if the power saving mode switching condition such as a residual amount of the battery, which is less than or equal to a threshold, is met, information for causing entry into the power saving mode or information for informing of actual entry into the power saving mode may be displayed on the touch screen 190 of the electronic device 100 in the form of a pop up window.

For example, if an emergency disaster message is received, information on the received message may be displayed on the touch screen 190 of the electronic device 100 in the form of a pop up window. Further, the reception of the information on the received message may be displayed on the status bar 192.

According to an embodiment of the present disclosure, if the electronic device 100 enters the power saving mode, the electronic device 100 may change one or more settings of the electronic device 100. According to an embodiment of the present disclosure, the electronic device 100 may change one or more settings of the electronic device 100 by parsing the received emergency disaster message. For example, the electronic device 100 may change a display mode of the touch screen 190, change a display method of the home menu, or set a certain application not to be used, where detailed embodiments thereof are described below.

The detailed structure of the electronic device 100 is described above as various examples of the electronic device 100 to which the present disclosure may be applied. However, as described above, the electronic device 100 according to an embodiment of the present disclosure is not limited to the electronic device 100 illustrated in FIGS. 1 and 2.

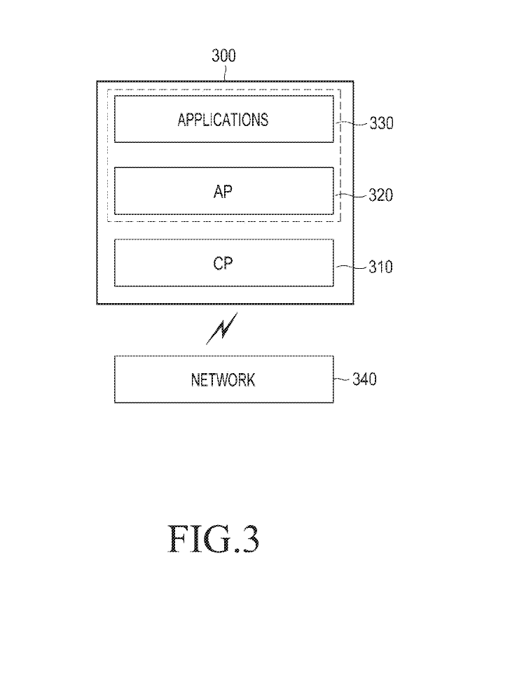

FIG. 3 is a block diagram of a power saving mode processing device 300 according to an embodiment of the present disclosure.

Referring to FIG. 3, the power saving mode processing device 300 according to an embodiment of the present disclosure may include a CP 310, an AP 320, and applications 330. In this case, the elements of the power saving mode processing device 300 may be implemented within the control unit 110 of FIG. 1.

The CP 310 may control an operation for providing a basic call function through a network 340 by controlling the communication module 120 of FIG. 1.

The AP 320 may boot an operating system and control an operation related to execution of applications 330 in an operating system environment. For example, the AP 320 may perform an operation for providing other functions except for the basic call-related function such as a camera function, a video reproduction, a music file reproduction, or the like.

The AP 320 may communicate with the CP 310 through a kernel data route. Accordingly, if the CP 310 receives basic call-related data, for example, a call or a message through the network 340, the AP 320 may receive the related data from the CP 310 through the kernel data route.

Further, if the booting of an operating system is completed, the AP 320 may control the electronic device 100 to enter a standby mode and display a standby screen on the touch screen 190. If a lock function is configured after booting is completed, a lock screen may be displayed.

The network 340 may be implemented regardless of an aspect of communication such as wired or wireless communication, and may be implemented by various communication networks including a personal area network (PAN), a local area network (LAN), a metropolitan area network (MAN), a wide area network (WAN), and the like. Further, the network 340 may be a known world wide web (WWW), and may use a wireless transmission technology utilized for short distance communication such as a standard of the Infrared Data Association (IrDA) or Bluetooth. In addition, the network 340 may include a cable broadcasting communication network, a terrestrial broadcasting communication network, and a satellite broadcasting communication network for receiving a broadcasting signal by the power saving mode processing device 300.

In a power saving mode operation according to an embodiment of the present disclosure, the CP 310 may minimize power consumption by blocking functions (for example, functions related to the network 340) related to various types of communication. If blocking functions related to the network 340, that is, a communication connection, the CP 310 according to an embodiment of the present disclosure may stop a communication stage by stage, and may determine a communication scheme to block a communication in consideration of various methods of blocking a communication based on at least one of a scheme having high power consumption, a scheme having a low use frequency, and a recently used scheme. For example, if the CP 310 is in a connection state through at least one communication scheme such as Bluetooth, wireless fidelity (Wi-Fi), and the like, the CP 310 may sequentially block the communication in consideration of at least one of the having high power consumption, the scheme having the low use frequency, and the recently used scheme.

The AP 320 according to an embodiment of the present disclosure may minimize power consumption by blocking execution of an application except for an application necessary in the power saving mode.

The CP 310 and the AP 320 may selectively apply at least one of the various methods of limiting functions to reduce power consumption, and the various methods of limiting functions are described below.

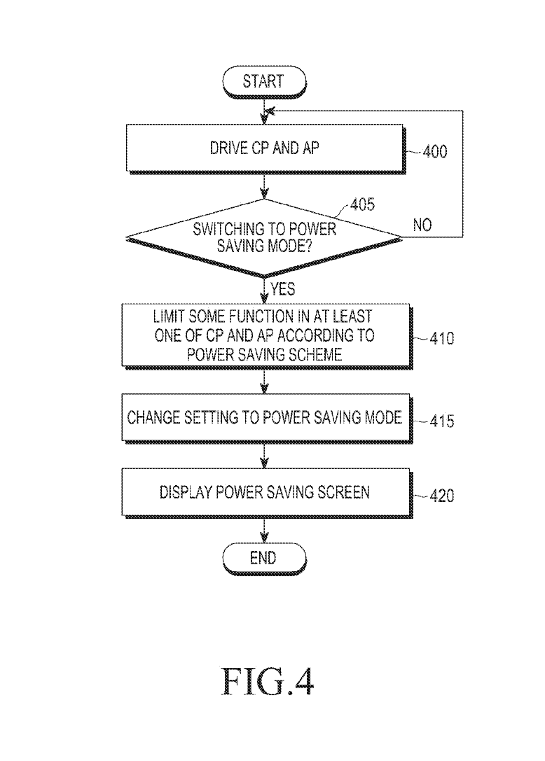

FIG. 4 is a flowchart of a method of switching to the power saving mode of the electronic device 100 according to an embodiment of the present disclosure. Referring to FIG. 4, the electronic device 100 may supply power to the CP 310 or the AP 320 in the normal mode and thus both the CP 310 and the AP 320 are driven (e.g. operated) in step 400. A standby screen may be displayed in such a state and may become a off-state screen after a preset time lapses.

As described above, in a state where both the CP 310 and the AP 320 are driven, a screen corresponding to a user input may be displayed by the AP 320. The screen may include, for example, a standby screen, a main menu screen, an application execution screen, or the like.

According to an embodiment of the present disclosure, in such a state, the electronic device 100 may determine whether switching to the power saving mode is selected in step 405. In a manual type, a user may switch to the power saving mode through a mode setting menu or the like. Further, in an automatic type, the electronic device 100 may switch to the power saving mode if a set power saving mode switching condition is met. Upon switching to the power saving mode, the electronic device 100 may limit some functions of at least one of the CP 310 and the AP 320 in accordance with the power saving scheme in step 410.

According to an embodiment of the present disclosure, driving of at least one of the CP 310 and the AP 320 may be blocked in accordance with the power saving scheme. For example, the driving of the AP 320 may be blocked and only the CP 310 may be driven in order to perform only a basic call-related function. In this case, peripheral devices such as the touch screen 190 and the keypad 166 may operate for a screen display and a key input. In this case, the basic call-related function such as a call, a message, or the like may be performed by the CP 310, and a minimum application for performing the basic call-related function may be executed. As described above, if only one processor is driven, power consumption is reduced and thus battery use time may be maximized.

According to an embodiment of the present disclosure, if switching to the power saving mode is selected in the normal mode in which both the CP 310 and the AP 320 are driven, the electronic device 100 may change a setting to the power saving mode in step 415. Subsequently, the electronic device 100 may display a power saving mode screen in step 420 according to switching to the power saving mode. Although FIG. 4 illustrates, as an example, a case where the driving of one processor is blocked if the electronic device 100 switches to the power saving mode, the electronic device 100 may limit some functions of the CP 310 or the AP 320 by a method selectively applied among the various methods of limiting functions for power saving.

According to an embodiment of the present disclosure, a method of executing a power saving mode in the electronic device 100 may limit an operation of driving one or more processors; an operation of detecting a command for switching to the power saving mode; and an operation of, if the command for switching to the power saving mode is detected, limiting operations of the one or more processors to block set functions other than a power saving call function in accordance with at least one of set power saving schemes.

According to an embodiment of the present disclosure, the one or more processors may include at least one of the CP 310 and the AP 320.

According to an embodiment of the present disclosure, the set power saving schemes may include at least one of a network limiting scheme for limiting transmission of information based on a network, a process limiting scheme for limiting the use of a background service in a screen off state, an application limiting scheme for limiting the use of other applications except for a set necessary application, and a screen limiting scheme for limiting a screen display.

According to an embodiment of the present disclosure, a command for switching to the power saving mode may be one of a request for switching a mode by a user and reception of an emergency message.

According to an embodiment of the present disclosure, an emergency message may be received from a server in response to a request from a designated user.

According to an embodiment of the present disclosure, in the network limiting scheme, the CP 310 may fix a network function (e.g. network address translation (NAT)) in order to increase a sleep period of a model if the screen is turned off.

According to an embodiment of the present disclosure, in a case of a network limiting scheme, a route table may be deleted to block mobile data transmission/reception between the AP 320 and the CP 310 if the screen is turned off.

According to an embodiment of the present disclosure, if a turned off screen is turned on, a route table may be reconstructed.

According to an embodiment of the present disclosure, in a case of the network limiting scheme, the CP 310 may block transmission of network information received from the network 340 to the AP 320 if a screen is turned off According to an embodiment of the present disclosure, in a case of a process limiting scheme, the process in the AP 320 may be pended if a screen is turned off and the process pended in the screen off state may be performed if the turned off screen is turned on.

According to an embodiments of the present disclosure, if a command for switching to the power saving mode is detected, if the electronic device 100 is connected based on at least one communication scheme, communication may be sequentially blocked based on at least one scheme having large power consumption, a scheme having a low use frequency, and a recently used scheme.

According to an embodiment of the present disclosure, the set necessary application may include at least one of a phone call application, a message application, and a web browser application.

According to an embodiment of the present disclosure, a screen limiting scheme may include at least one of an operation of changing a screen brightness to a predetermined value and an operation of switching a screen to a gray mode.

According to an embodiment of the present disclosure, if a command for switching to the power saving mode is detected, a power saving screen may be displayed, which is configured using at least one of a control of brightness of a screen of a display unit, switching of a screen of the display unit to a gray mode, switching of a home screen of the display unit to a home screen of a minimum function, and deactivation of other applications except for a set necessary application.

Hereinafter, various embodiments of the present disclosure are described based on a network power saving scheme, a process power saving scheme, an application limiting power saving scheme, and a screen power saving scheme, which are largely divided from the power saving schemes to limit various functions. Among the power saving schemes, at least one power saving scheme may be selectively applied.

Further, according to an embodiment of the present disclosure, a function for gradually controlling power saving modes according to at least one power saving scheme selected from the power saving schemes may be provided.

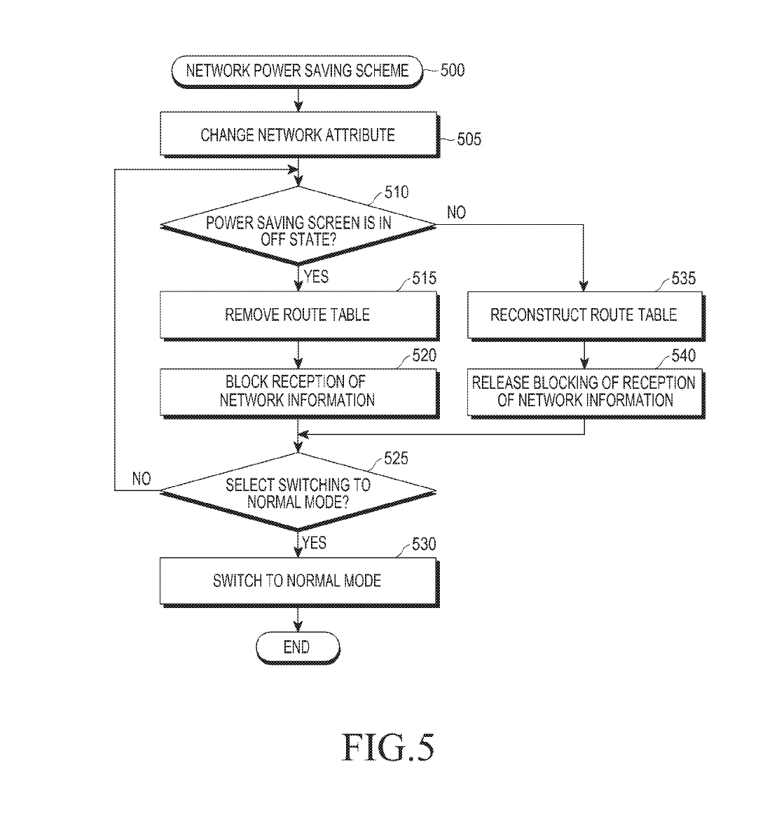

FIG. 5 is a flowchart of a method of a power saving mode based on a network power saving scheme according to an embodiment of the present disclosure. The network power saving scheme may refer to a scheme for limiting transmission of information based on a network.

Referring to FIG. 5, the electronic device 100 according to an embodiment of the present disclosure may change network attributes in step 505 in a case of the network power saving scheme 500. In this case, the electronic device 100 may not search for another network by changing a network preference into one attribute. For example, in order to increase a sleep period of a modem if a screen is turned off, the CP 310 may fix a network function (e.g. NAT) and, accordingly, set the network preference to be fixed to a wideband CDMA (WCDMA) network.

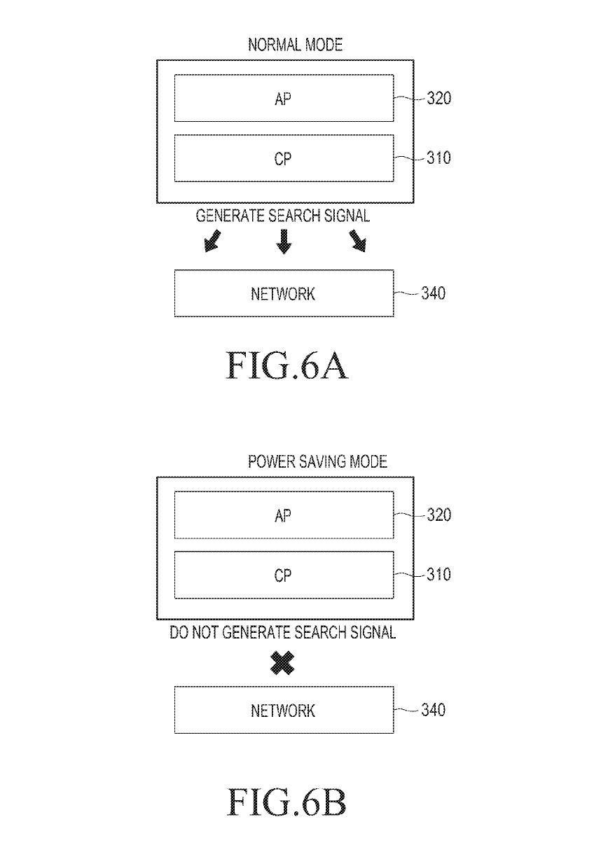

FIGS. 6A to 9B are block diagrams of network signal processing between a normal mode and a power saving mode according to embodiments of the present disclosure.

Referring to FIG. 6A according to an embodiment of the present disclosure, if the electronic device 100 accesses a WCDMA-based 3G network in the normal mode, the CP 310 may generate a search signal for a long term evolution (LTE) connection in order to perform an operation for an Internet connection according to a user input. If the electronic device 100 accesses an LTE network, in order to provide a voice service for a call, the CP 310 may generate a signal for a 3G network search to search for a 3G network. In this case, LTE does not provide a circuit switching (CS)-based voice service. Accordingly, based on the fact that the basic call has a highest priority in the power saving mode, power consumption may be reduced if the search for the network for LTE is blocked.

Referring to FIG. 6B according to an embodiment of the present disclosure, the 3G network is fixed in the power saving mode. Accordingly, the CP 310 has only to maintain the 3G mode and thus does not generate a search signal for searching for another network. As a result, the search signal for another network is not generated, and the CP 310 may reduce power consumption according to the generation of the search signal. As described above, after the network attribute is changed, the electronic device 100 may deactivate an LTE icon displayed on the status bar and display the power saving screen in which the use of LTE is limited. The power saving screen may go to an off state if a predetermined time lapses. However, battery consumption may be high in a weak electric field having a signal strength less than or equal to a predetermined strength in the 3G network after the LTE network is blocked, so that the electronic device 100 may return to the network for LTE to save power.

According to an embodiment of the present disclosure, as described above, for the Internet connection in the normal mode, the CP 310 may generate a search signal for the LTE connection or generate a signal for searching for the 3G network for a voice service, and transmission of the search signal is performed according to a predetermined first period. However, in the power saving mode, the transmission may be performed according to a second period rather than the first period of the normal mode. In this case, the second period may be longer than the first period, and a length thereof may be determined according to a network environment. For example, if the electronic device 100 is located in an area where service is impossible in the power saving mode, searching for a network according to the predetermined first period causes unnecessary power consumption. Accordingly, the CP 310 according to an embodiment of the present disclosure may reduce power consumption by increasing the network search period.

Further, according to an embodiment of the present disclosure, if the electronic device 100 moves to a roaming area, the electronic device 100 performs a periodic network search to find a network having a better quality than that of the current network, for example, a network having a higher priority. However, the CP 310 according to an embodiment of the present disclosure may stop the network search for a better quality network in the power saving mode even though a roaming situation occurs.

Accordingly, the electronic device 100 may determine whether a power saving screen is in an off state in step 510 according to various embodiments of the present disclosure. If the power saving screen is in the off state, the electronic device 100 may remove a route table in a kernel region in step 515. If the route table is removed, the use of mobile data may be limited in the screen if the screen is in the off state. The route table may include route information for allowing the AP 320 to select a corresponding network interface to transmit data to a given destination. Since the type of information contained in a route table is known, a detailed description thereof is omitted here.

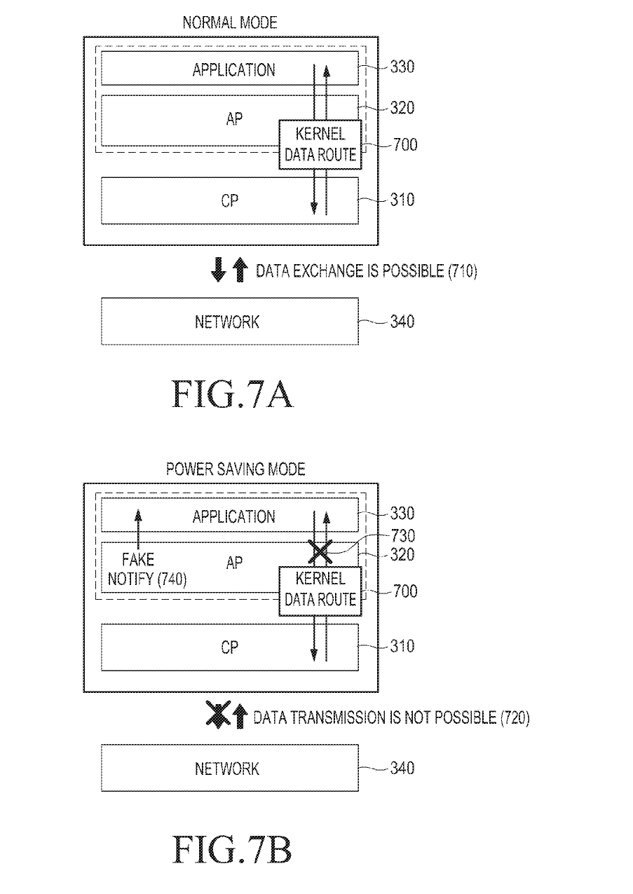

Referring to FIG. 7A according to an embodiment of the present disclosure, the AP 320 may make a request for data to the CP 310 through a kernel data route 700 in the normal mode and, accordingly, the CP 310 may exchange data with the network 340, that is, transmit and receive data from/to the network 340 as indicated by reference numeral 710.

However, if the power saving screen is turned off in the power saving mode according to an embodiment of the present disclosure, a route table is removed from the kernel region and thus the kernel data route 700 between the AP 320 and the CP 310 may be blocked as indicated by reference numeral 730 of FIG. 7B. That is, if the route table is removed, the AP 320 corresponding to an actual platform area cannot know the route, so that data transmission to the CP 310, which serves as a modem or exists within a modem, may be impossible. Accordingly, a socket cannot be generated and the AP 320 may determine that the connection with the network 340 is disconnected.

Further, the CP 310 may receive data from the network 340 but cannot transmit data to the network as indicated by reference numeral 720 and, accordingly, the CP 310 may not transmit the data received from the network 340 to the AP 320. That is, the CP 310 may wake-up the AP 320. As described above, if a screen is in the off state, it is possible to prevent the AP 320 from being woken up by anything other than an allowed processor.

Then, data may not be transmitted to the CP 310 from the network 340, because, from the point of view of the AP 320, the connection with the network 340 is disconnected and thus a socket cannot be generated. For example, the electronic device may be implemented to not use a push service of a messenger application and, if the electronic device 100 is in a screen on state, and may be implemented to notify of message reception information.

According to an embodiment of the present disclosure, the AP 320 cannot transmit data to the CP 310 and thus considers that the connection is disconnected. As a result, the AP 320 may notify of a disconnected state to a corresponding application 330 as indicated by reference numeral 740 in FIG. 7B. However, since the connection between the CP 310 and the network 340 is still maintained in practice, the notification may actually correspond to a fake notify 740. If reception of mobile data is requested or blocked whenever the screen is turned on/off, a request for a data connection or disconnection is transmitted to the network 340 every time, so that network speed decreases and also the network itself is overloaded due to the request. In addition, since a connection or a disconnection operation in the CP 310 is also performed, the electronic device 100 may consume a large amount of power. However, according to an embodiment of the present disclosure, the connection between the CP 310 and the network 340 is normally maintained regardless of the screen turning on/off and thus, even though the screen turns on/off repeatedly, power consumption is not generated by the repetitive operation. Therefore, the power consumption may be minimized through the removal of only the route table.

Further, according to an embodiment of the present disclosure, the AP 320 transmits/receives no data and the data received by the CP 310 is not transmitted to the AP 320, so that power consumption may be minimized by controlling waking-up and blocking data transmission/reception.

In addition, according to an embodiment of the present disclosure, the electronic device 100 may block reception of network information in step 520 in FIG. 5. For example, reception of information on a network-related function such as network identity and time zone (NITZ) may be blocked. Accordingly, in the screen off state, the electronic device 100 does not receive network time information from the network 340 and, accordingly, does not need to update reception of the network time information, thereby reducing power consumption. That is, the CP 310 does not need to wake up to receive network information, thereby minimizing power consumption. In this case, according to an embodiment of the present disclosure, the electronic device 100 may update time information based on real time clock (RTC) information of the electronic device 100. The electronic device 100 may block not only the network information but also a proactive command. The proactive command is a command that is transmitted to the CP 310 from a SIM card of the electronic device 100, and the CP 310 may transmit a request based on the proactive command to a server existing in the network according to the proactive command. Accordingly, in the power saving mode according to an embodiment of the present disclosure, it is possible to block the proactive command using the network and reduce power consumption.

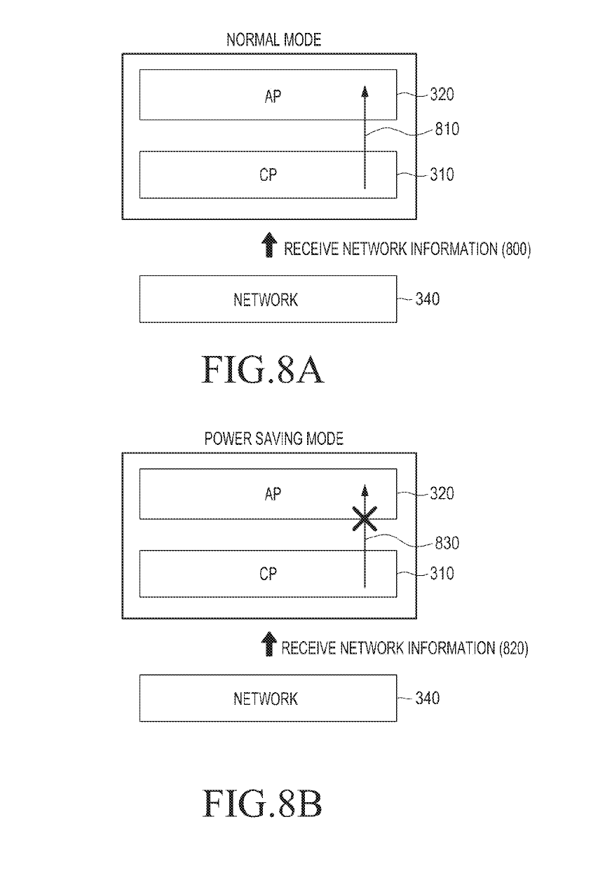

FIG. 8A illustrates a case 810 where data transmission/reception is performed between the AP 320 and the CP 310 if network information is received in the normal mode as indicated by reference numeral 800. In the normal mode, the AP 320 may receive network information transmitted through the CP 310.

FIG. 8B according to an embodiment of the present disclosure illustrates a case 830 where the received network information is not transmitted to the AP 320 if the network information is received in the power saving mode as indicated by reference numeral 820. The network information is not transmitted to the AP 320 in the screen off state of the power saving mode. That is, even though the CP 310 receives the network information from the network 340, the CP 310 filters the network information and does not transmit the network information to the AP 320. Accordingly, there is an effect of blocking the waking-up of the AP 320 by the CP 310. In this case, the network information corresponds to the network-related function such as NITZ and may refer to control information rather than user information.

Subsequently, the electronic device 100 according to an embodiment of the present disclosure determines whether switching to the normal mode is selected in step 525 in FIG. 5 and, if switching to the normal mode is selected, switches to the normal mode in step 530. In contrast, if switching to the normal mode is not selected in step 525, the electronic device 100 determines whether the power saving screen is in the off state in step 510. If the screen is turned on by a user, the electronic device 100 may reconstruct the route table in step 535.

For example, the route table, which existed in the kernel region, is removed if the screen is turned off, but route information on a destination within a link property corresponding to a region which may be accessed by the AP 320 is not removed. Accordingly, if the screen is turned on, the AP 320 reconstructs the route table based on the route information on the destination.

Alternatively, if the screen is turned on, the electronic device 100 may make a request for a data call list to the network 340, and update the route table based on a response to the request.

The electronic device 100 according to an embodiment of the present disclosure may release the blocking of the reception of the network information in step 540. Accordingly, the electronic device 100 may perform an operation of updating the network time. Thereafter, the method may return to step 510 and repeatedly perform the aforementioned processes unless switching to the normal mode is selected in step 525.

As described above, according to an embodiment of the present disclosure, by processing operations, which were stopped in the screen off state, at once if the screen is turned on, periodic reception of the network information and transmission/reception of data for the operation executed in the background are blocked in the screen off state, and thus unnecessary power consumption generated in the screen off state may be prevented.

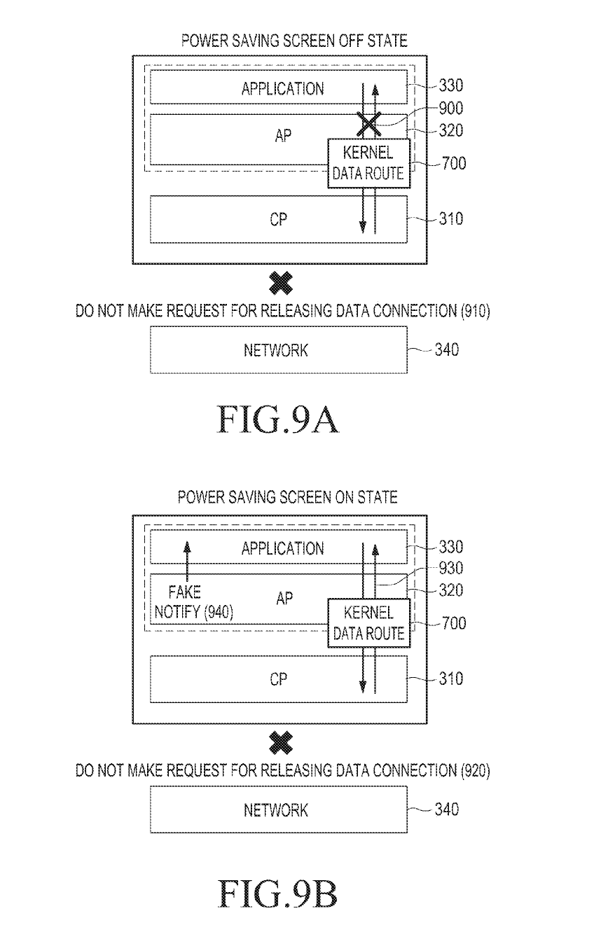

Then, operations of the CP 310 and the AP 320 in a power saving screen off state and a power saving screen on state are described below in more detail with reference to FIGS. 9A and 9B.

FIG. 9A illustrates a case 900 where data transmission/reception between the AP 320 and the CP 310 through the kernel data route 700 is blocked if the power saving screen is in the off state. As illustrated in FIG. 9A, since the removal of the route table corresponds to a removal of internal route information, the CP 310 does not make a request for releasing the data connection to the network 340. Accordingly, the connection between the CP 310 and the network 340 may be normally maintained. As described above, the method of blocking the data in the screen off state corresponds to a blocking method using the route table, which is not in the physically disconnected state in practice.

FIG. 9B illustrates a case 930 where the route table is reconstructed and data transmission/reception between the AP 320 and the CP 310 through the kernel data route 700 is performed if the power saving screen is in the on state. Then, the AP 320 may consider that the connection with the network 340 is made again through the reconstructed route table and notify the application 330 of a connected state as indicated by reference numeral 940. However, since the connection between the CP 310 and the network 340 has not been released in practice, the notification may actually correspond to a fake notify 940. Further, since the connection between the CP 310 and the network 340 is normally maintained, a separate data connection request is not needed as indicated by reference numeral 920. As described above, according to an embodiment of the present disclosure, since the route table is removed or reconstructed if the screen is turned off or on, it is not required to transmit the request for the connection/disconnection operation to the network 340, so that network speed increases. Further, the CP 310 does not need to perform the connection/disconnection operation with the network 340, thereby minimizing power consumption. That is, the disconnection or the connection is made only in the AP 320 and the CP 310 and the network 340 have no additionally required operations, thereby improving power consumption.

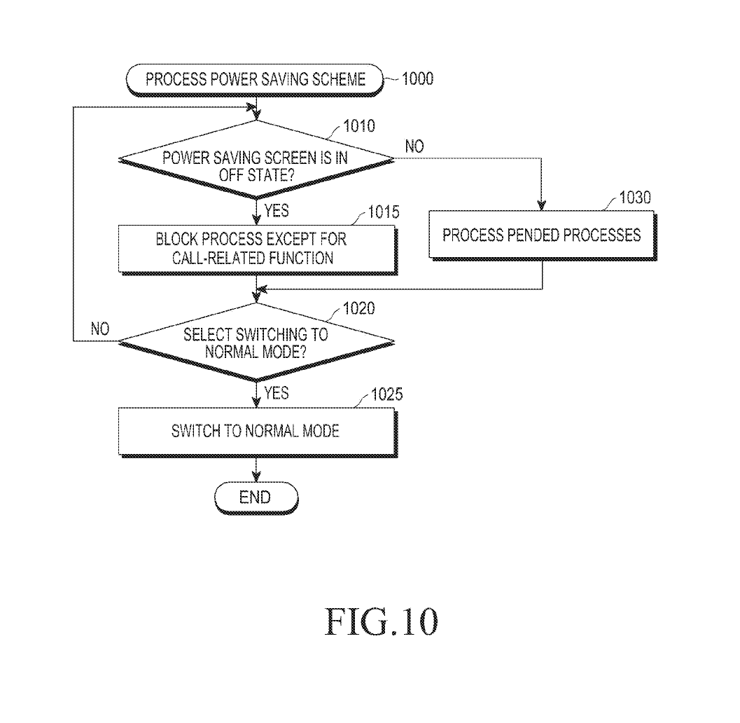

FIG. 10 is a flowchart of a method of a power saving mode based on a process power saving scheme according to an embodiment of the present disclosure. The process power saving scheme corresponds to a scheme for limiting the use of a background service in the screen off state and limits an operation of the AP 320.

Referring to FIG. 10, in a case of the process power saving scheme 1000, the electronic device 100 according to an embodiment of the present disclosure may determine whether the power saving screen is in the off state in step 1010. Hereinafter, the process power saving scheme is performed by the AP 320 but may be performed by the CP 310 or the control unit 110 with reference to operation information on the AP 320. Subsequently, the electronic device 100 may determine whether the power saving screen is in the off state in step 1010.

If the power saving screen is not in the off state in step 1010, the electronic device 100 according to an embodiment of the present disclosure may stop at least one process to not be used in the power saving mode according to the process power saving scheme. For example, in an emergency situation requiring power saving, the electronic device 100 may stop at least one process except for the process of enabling only a power saving call function, changing a display mode of the touch screen 190, changing a display method of the home menu, or setting the use of a particular application to be not available. As described above, by stopping at least one process to not be used in the power saving mode, the operation of an unnecessary application may be blocked.

If the power saving screen is in the off state in step 1010, the electronic device 100 according to an embodiment of the present disclosure may block the process in the AP 320 except for the call-related function in step 1015. Accordingly, a list of the processes to be processed in the screen off state, for example, an alarm process table may be removed.

The blocking of the process according to an embodiment of the present disclosure may refer to an operation of limiting the process, and the limited process may include, for example, limiting a starting of a process by a real time communication (RTC) interrupt, a starting of an application process, and a synchronization operation. Among them, the RTC interrupt refers to all interrupts registered in the unit of time and all tasks requested to be processed by the control unit 110, that is, the CPU may be blocked by the interrupts.

Accordingly, if the control unit 110 executes a program, if a device such as input/output hardware has something to process or an exceptional situation to be processed occurs, the control unit 110 may be informed of it. According to an embodiment of the present disclosure, processing required by the interrupt may be temporarily halted (e.g. then pending) in the screen off state and then may be performed if the screen is turned on. Further, if a third party application makes a request for processing the process to the control unit 110, the control unit 110 does not process the request in the screen off state but may then perform processing if the screen is turned on. For example, other functions except for a signal received in a control message form such as a call, a message, or the like may be blocked. Accordingly, the electronic device 100 may be implemented to not use the push service in the screen off state and to notify of push information if the screen is turned on. The AP 320 may be implemented to not execute all processors for synchronization. As described above, in the screen off state, processing of all processes except for a system area and a network area may be halted (e.g. then pending) in a buffer queue.

Instead of processing tasks whenever the processing is requested by the interrupt generated during the screen off state, the control unit 110 according to an embodiment of the present disclosure may store the tasks in the buffer queue. That is, as the tasks requested to be processed are added to the buffer, an alarm process table indicating tasks, which should be processed while the screen is actually turned off, may be removed.

According to an embodiment of the present disclosure, in a state where the power saving mode is maintained, the electronic device 100 may determine whether switching to the normal mode is selected in step 1020. If switching to the normal mode is selected in step 1020, the electronic device 100 may switch to the normal mode in step 1025. In contrast, if switching to the normal mode is not selected in step 1020, the method returns to step 1010 and determines whether the power saving screen is in the off state. If a turned off power saving screen is turned on, the electronic device 100 processes the pending processes in step 1030 and the method proceeds to step 1020. Accordingly, the processes pending in the buffer queue may be processed at once. The method returns to step 1010 and repeatedly performs the aforementioned processes unless switching to the normal mode is not selected in step 1020.

According to an embodiment of the present disclosure, in the power saving mode, registration of an alarm manager 3rd party application service may be limited. Accordingly, the use of a background service of the corresponding application may be limited.

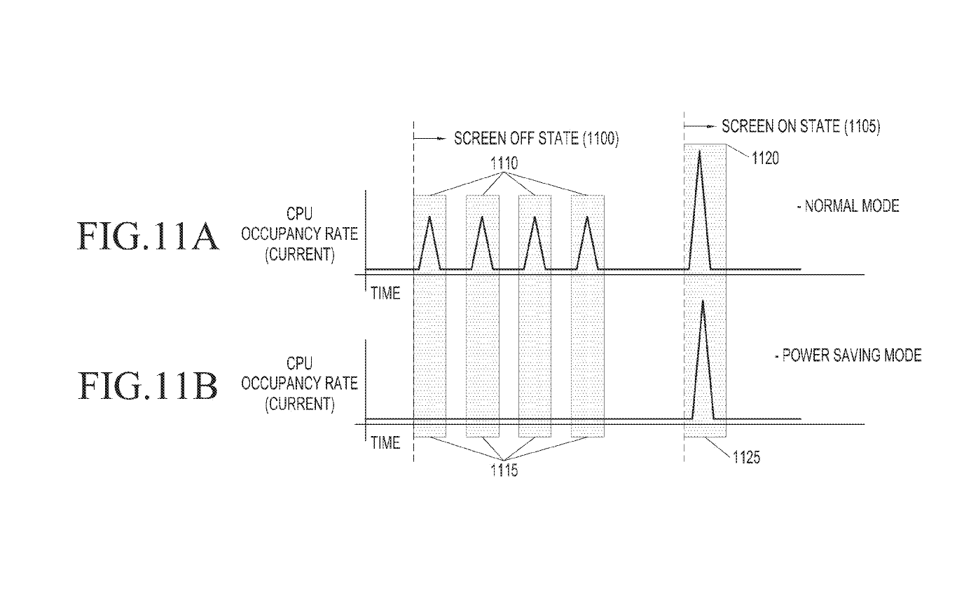

FIGS. 11A and 11B illustrate current consumption in the electronic device 100 according to the screen off/on state in each of the normal mode and the power saving mode.

Referring to FIG. 11A, in the normal mode, four alarms and a process start may be generally attempted in a screen off state 1100 as indicated by reference numeral 1110. In the normal mode, partial wake-up corresponding to the attempt 1110 may be generated. Current consumption may occur whenever the wake-up is generated. Thereafter, if the screen is in the on state 1105, the AP 320 wakes-up and controls operations related to execution of various applications 330, thereby consuming large amounts of power.

In contrast, as illustrated in FIG. 11B according to an embodiment of the present disclosure, the electronic device 100 may maintain a sleep state without waking up the CPU of the electronic device 100 in the screen off state according to an embodiment of the present disclosure. Accordingly, since an attempt of the alarm and the process start is blocked in the screen off state while the electronic device 100 operates in the power saving mode as indicated by reference numeral 1115, it is noted that the partial wake-up may not be generated. Therefore, there is no current consumption due to the attempt in the screen off state. In contrast, if the screen is turned on, all of the halted (e.g., then pending) tasks, for example, the operations of the alarm and the processor may be processed at once as indicated by reference numeral 1125.

As described above, the partial wake-up is not generated in the screen off state in the power saving mode according to an embodiment of the present disclosure, so that the power saving effect may be created. For example, if the partial wake-up is generated, the electronic device 100 does not enter the sleep mode immediately after the task is completed, but may enter the sleep mode after several seconds to several minutes since it takes time to stabilize the AP 320 or the CP 310. Accordingly, due to the limiting of the partial wake-up, current consumption may be significantly reduced even in consideration of the required time. Further, according to an embodiment of the present disclosure, even though the screen is turned on and all tasks are processed at once, the electronic device 100 is in the full wake-up state, which is the same as that in the normal mode. Accordingly, additional current is not consumption as compared to the normal mode. That is, although the pending tasks are processed at once, the current equal to that in the normal mode is consumed.

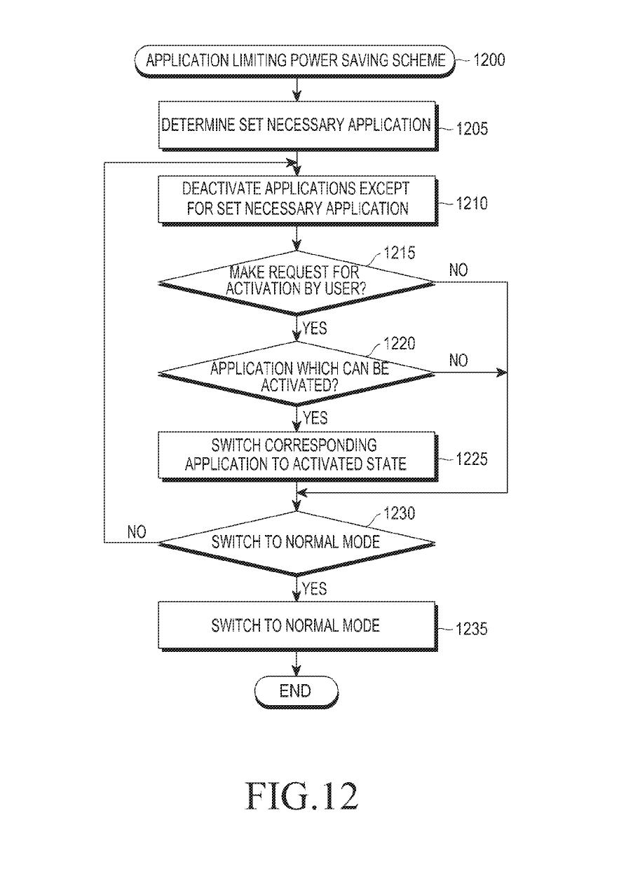

FIG. 12 is a flowchart of a method of a power saving mode based on an application limiting power saving scheme according to an embodiment of the present disclosure. In this case, the application limiting power saving scheme refers to a scheme for limiting the use of other applications except for the set necessary application.

Referring to FIG. 12, in a case of the application limiting power saving scheme 1200, the electronic device 100 may determine the set necessary application in step 1205, and then deactivate applications except for the set necessary application in step 1210.

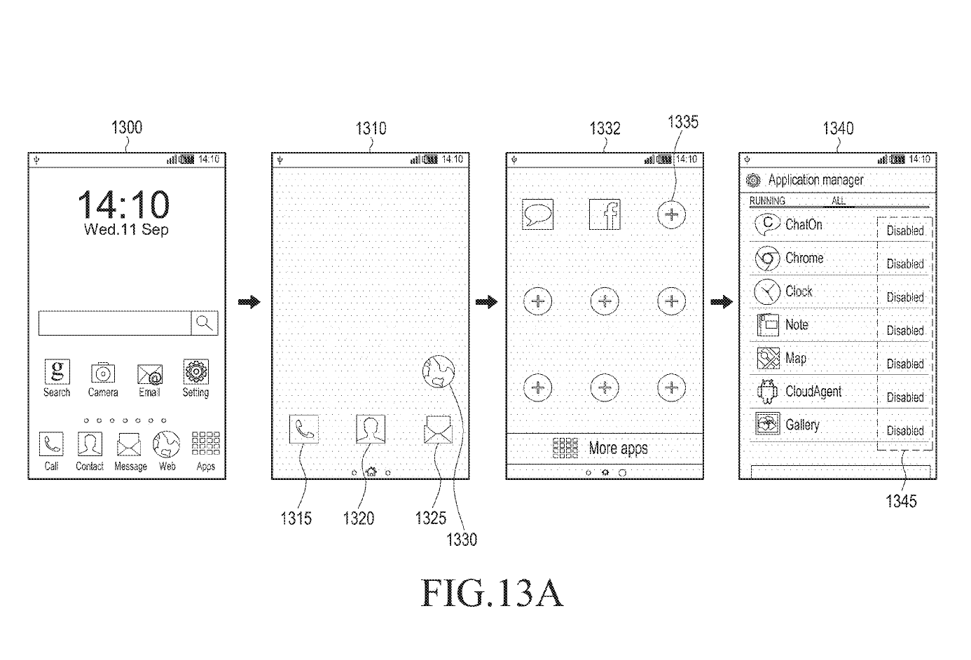

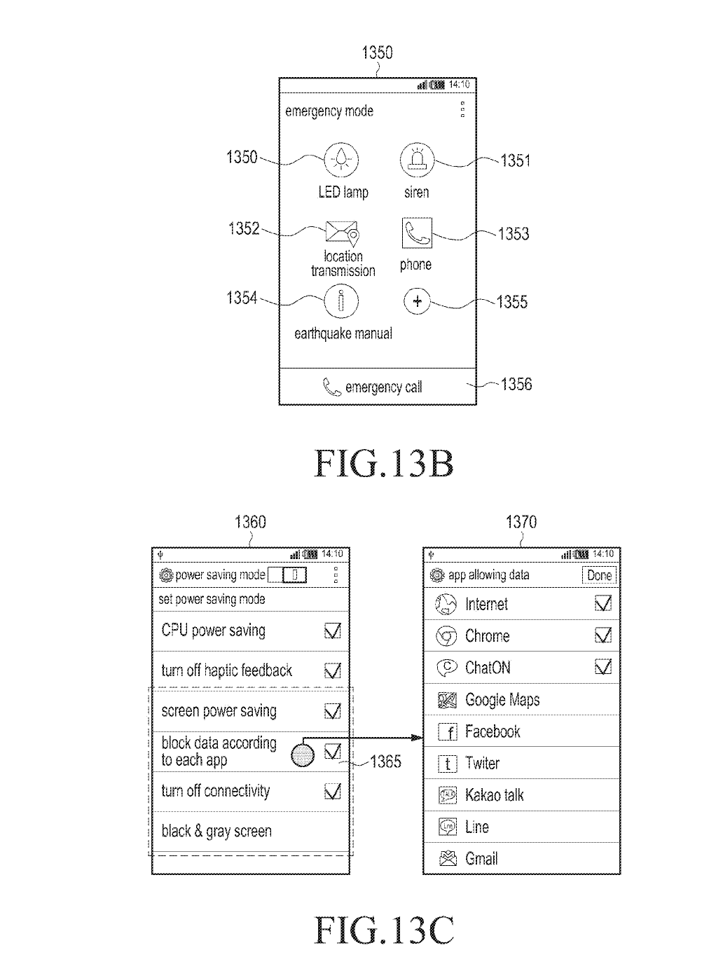

FIG. 13A illustrates the electronic device 100 changing a home screen configuration according to a setting of the power saving mode according to an embodiment of the present disclosure.

Referring to FIG. 13A, when the electronic device 100 switches to the power saving mode according to an embodiment of the present disclosure as described above, the electronic device 100 may provide a home screen 1310 dedicated for the power saving mode in which only minimum functions are left and other applications or functions are removed from a home screen 1300. Accordingly, the power consumption may be minimized in the power saving mode.

As illustrated in FIG. 13A, the electronic device 100 may switch the home screen 1300 to the home screen 1310 in which the minimum functions are displayed, and may use the minimum functions, that set necessary applications (for example, a phone call application 1315, a contact application 1320, a message application 1325, a web browser application 1330, and the like). Then, if a user selects a main menu switching key, a menu screen 1332 may be displayed on the touch screen 190 referred in FIG. 1, and the other applications except for the set necessary applications may be displayed in an inactive state on the menu screen 1332 or processed to be hidden as indicated by reference numeral 1335.

According to an embodiment of the present disclosure, the applications displayed on the home screen 1300 may be divided into a case where data transmission/reception through the network is required and a case where the data transmission/reception is not required if the applications are selected (or launched). For example, since the web browser application 1330 is an application requiring data transmission/reception, the web browser application 1330 may be allowed only if the web browser application 1330 is registered in the launcher. If the web browser application 1330 is not registered in the launcher, the web browser application 1330 may be displayed in the inactive state. Further, since the message application 1325 does not require data transmission/reception to/from the network if the user desires to see the content contained in the existing message, the message application 1325 may operate in a state where the electronic device is not connected to the network. That is, in the home screen 1310 dedicated for the power saving mode, the message application 1325 may be executed and thus a user may see the content contained in the existing message, but reception/transmission of a new message may be limited. However, if the message application 1325 is registered in the launcher, data use may be possible. Accordingly, if the message application 1325 is registered in the launcher, the reception/transmission of the message may be performed in the power saving mode.

FIG. 13B illustrates a screen example of the home screen in the emergency mode of the electronic device 100 according to an embodiment of the present disclosure.

Referring to FIG. 13B, if the electronic device 100 switches to the emergency mode, necessary applications (for example, an LED lamp 1351, a siren 1352, location transmission 1353, a phone 1354, an earthquake manual 1355, an emergency call 1357, and the like) may be displayed on the home screen 1350. At this time, an “+” icon 1356 may indicate a hidden application or may be used as a button for adding an application

In addition, even though the remaining applications except for the set necessary applications are deactivated as described above, the electronic device 100 may be implemented to manually activate a particular application by the user among the deactivated applications according to an embodiment of the present disclosure.

FIG. 13C illustrates a screen for describing a power saving mode setting scheme in the electronic device 100 according to an embodiment of the present disclosure.

If a power saving mode setting menu is selected by a user, a power saving mode setting screen 1360 may be displayed as illustrated in FIG. 13C. The user may set whether to use functions limited in the power saving mode on the power saving mode setting screen 1360. If the user selects, for example, a data blocking function according to each application 1365, an application list screen 1370 may be displayed. The user may select at least one application to be allowed in the power saving mode through a check box with respect to each application of the application list screen 1370.

As described above, data for other applications except for the application designated by the user or the basic application in the emergency/power saving mode may be blocked.

According to an embodiment of the present disclosure, if there is a user's request for activating at least one application among the deactivated applications displayed as “disabled” 1345 on a screen 1340 displaying the application list in step 1215 as illustrated in FIG. 13A, the electronic device 100 may determine whether the corresponding application is an application which may be activated in the power saving mode in step 1220. If the application of which the activation is requested by the user is determined to be an application which may be activated in the power saving mode, the corresponding application is switched to an activated state in step 1225.

In contrast, if the application of which the activation is requested by the user is determined to not be an application which may be activated in the power saving mode, the corresponding application is maintained in the deactivated state. Then, the deactivated state of the application may be processed to have the same effect generated if the corresponding application is removed. Accordingly, for example, power consumption generated by the operation of the corresponding application in a background of the electronic device 100 may be prevented.

According to an embodiment of the present disclosure, whether the application may be activated in the power saving mode may be determined in consideration of a degree of the power consumption of the corresponding application. For example, an application having large power consumption such as a game may not be activated even by a user's request, and an application frequently used and having small power consumption such as a messenger may switched to the deactivated state by default and may be switched to the activated state according to a user's selection.

Further, based on usability, a maximum of N applications which the user desires may be activated. For example, if a maximum of 3 applications are set to be activated and applications A, B, C, and D are deactivated, if the user desires to use the applications A, B, and C, the user may switch the applications A, B, and C to the active state and then use them. However, if the user desires to use the application D, the user may release the inactive state of the application D after limiting the use of one of the applications A, B, and C. As described above, the maximum number of applications which may be activated by be randomly changed.

In such a state, if a command for switching to the normal mode is input (or detected) in step 1230, the electronic device 100 may switch to the normal mode in step 1235. If the command for switching to the normal mode is not input (or detected), the method may return to step 1210 and repeatedly perform the aforementioned process.

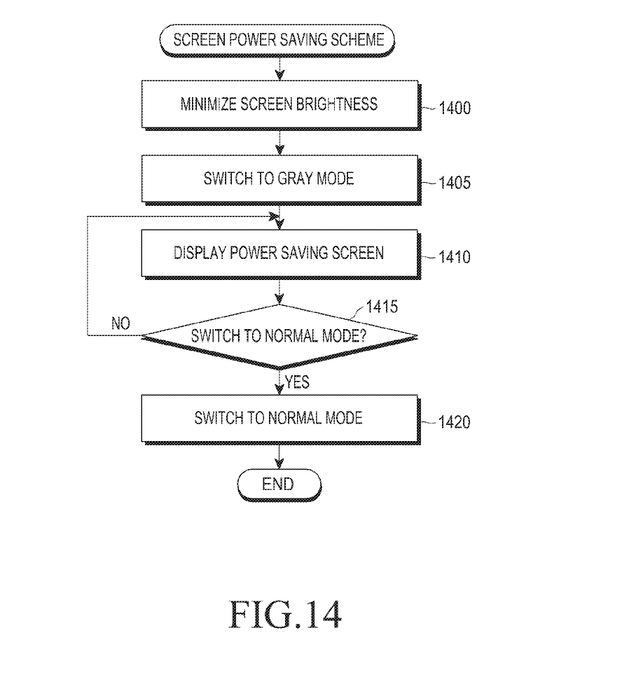

FIG. 14 is a flowchart of a method of a power saving mode based on a screen power saving scheme according to an embodiment of the present disclosure.

Referring to FIG. 14, if there is a command for switching to the power saving mode according to an embodiment of the present disclosure, the electronic device 100 may minimize screen brightness in step 1400. In this case, minimizing the screen brightness refers to setting the screen brightness to a predetermined brightness which enables reading by a user. For example, if a maximum value of screen brightness is 100 and a black screen has a value of 0, a value corresponding to 10% may be set as a minimum value of screen brightness, and the minimum value of screen brightness may be controlled.

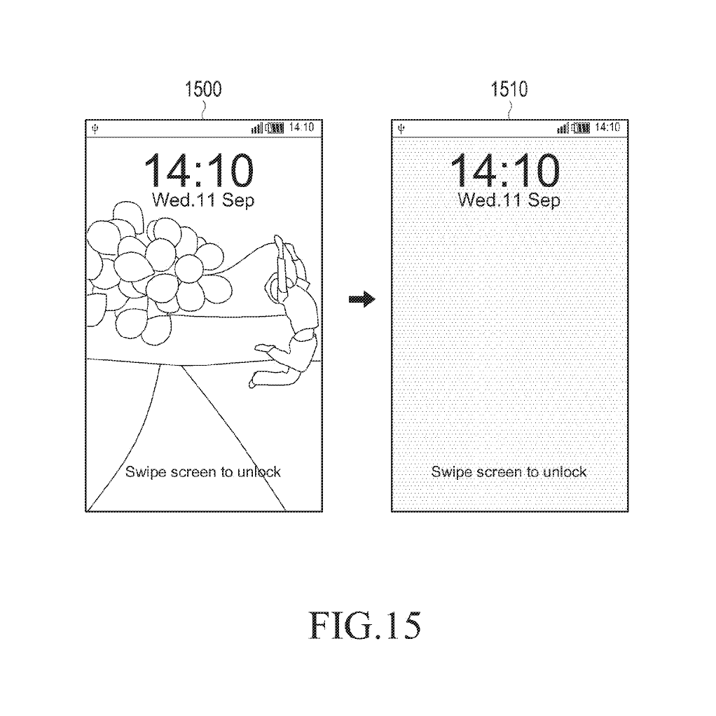

Further, the electronic device 100 may display a power saving screen 1510 of FIG. 15 in step 1410 in FIG. 14 changing a display unit screen 1500 of the electronic device illustrated in FIG. 15 in step 1405 of FIG. 14. If an animation is executed in the display unit screen 1500 of FIG. 15, if the electronic device 100 switches to the power saving mode, the execution of the animation is stopped and a power saving screen 1510 in a stopped state may be displayed. By stopping the execution of the animation, the AP 320 does not need to make an additional calculation and may reduce current consumption. In such a state, if a command for switching to the normal mode is input (or detected) in step 1415 of FIG. 14, the electronic device 100 may switch to the normal mode in step 1420. If the command for switching to the normal mode is not input (or detected), the method may return to step 1410 and repeatedly perform the aforementioned process. The power consumption may be reduced by decreasing a resolution of the screen as well as the screen brightness.

In addition, a situation requiring switching to the power saving mode may include, for example, an emergency disaster situation. For example, if battery consumption of the electronic device 100 may be minimized if the emergency disaster situation occurs, it is possible to increase the time for external contact in a dangerous situation and thus significantly increase the chance of rescue and survival.

Hereinafter, a method of minimizing battery consumption of the electronic device 100 if an emergency disaster situation occurs is described with an example according to an embodiment of the present disclosure.

An embodiment of the present disclosure discloses an apparatus and a method for switching a mode by an emergency disaster message which may minimize power consumption of the electronic device 100 if an emergency disaster situation occurs by, if an emergency disaster message is received, analyzing the received emergency disaster message and switching a mode of the electronic device 100 to a particular mode among a plurality of modes preset according to each urgent situation based on the content contained in the analyzed message.

In an embodiment of the present disclosure, the received emergency disaster message is analyzed and it is determined whether to switch the mode according to the analyzed message. Then, one emergency mode is set and the electronic device 100 may switch to the one set emergency mode according to the content of the analyzed message. Further, a plurality of emergency-related modes is set and a plurality of modes is switched according to the content of the analyzed message in stages.

In addition, any type of emergency disaster message may be applied to the present disclosure if the emergency disaster message which may be received by the electronic device 100. For example, the emergency disaster message may be a message provided from a predetermined service server that provides emergency information. For example, if an emergency disaster situation (for example, a typhoon, a tsunami, an earthquake or the like) occurs, the emergency disaster message may be a message provided by a CBS, an ETWS or the like, which provides emergency disaster information, but the present disclosure is not limited thereto.

A type of the emergency disaster message may be a predetermined form of a message defined by a mobile communication standard or may be a short message. Further, the emergency disaster message may include at least one of a piece of disaster type information, information related to a time of a disaster, information related to a distance to a disaster region, and information related to a level of disaster.

In addition, in the description below, the term “emergency-related mode” may include a “warning mode” or an “emergency mode” according to a disaster risk state. If the emergency-related mode is set as one mode, the “emergency-related mode” may refer to the “emergency mode.”

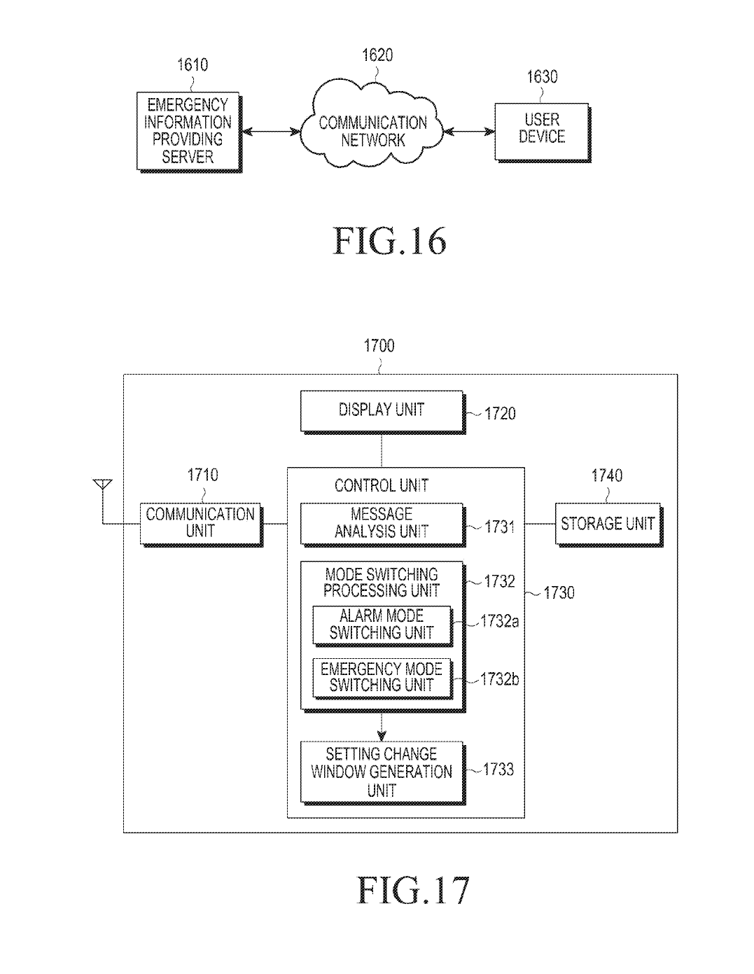

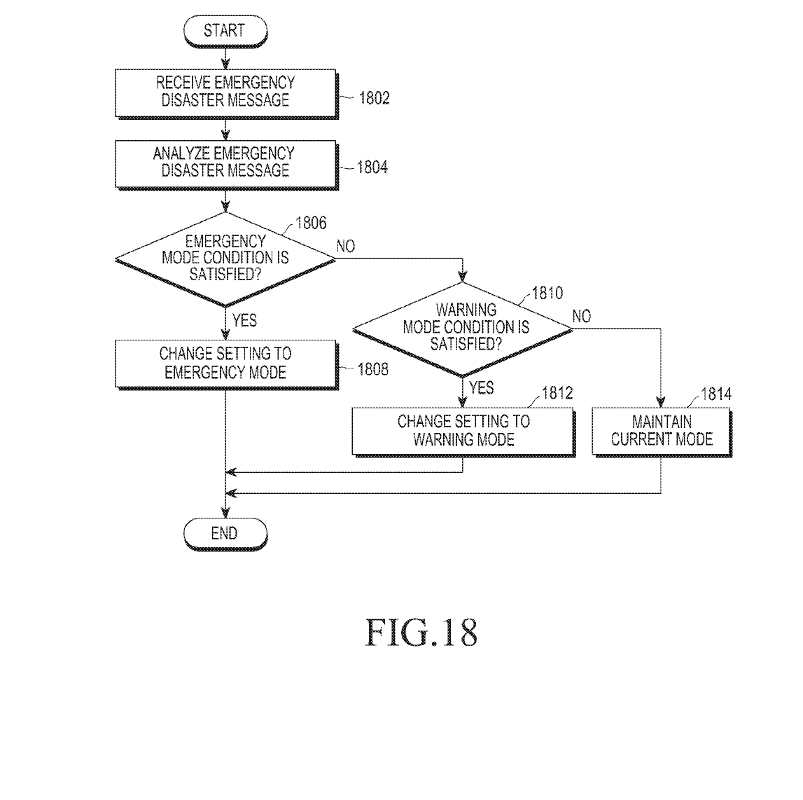

A system and a structure of an apparatus according to an embodiment of the present disclosure is described below with reference to FIGS. 16 to 17, and then a method according to an embodiment of the present disclosure is described below in more detail with reference to FIGS. 18 to 22.

FIG. 16 is a block diagram of an emergency disaster message transmission system according to an embodiment of the present disclosure.

Referring to FIG. 16, the emergency disaster message transmission system according to an embodiment of the present disclosure may include an emergency information providing server 1610, a communication network 1620, and a user device 1630.

The emergency information providing server 1610 performs a function of generating an emergency disaster message and transmitting the generated emergency disaster message to each user device 1630 (for example, an electronic device). Then, the transmitted emergency disaster message may include at least one of a piece of disaster type information (for example, earthquake, tsunami or the like), information related to a time of a disaster, information related to a distance to a disaster region, and information related to a level of disaster (for example, earthquake intensity, tsunami intensity or the like).

Further, the emergency disaster message type may be generated in a predetermined form of a message defined by a mobile communication standard and transmitted by a mobile communication standard protocol. For example, the emergency disaster message may be transmitted in a form of a short message.

As described above, the emergency disaster message transmitted by the emergency information providing server 1610 is transmitted to the user device 1630 through the communication network 1620. Then, the user device 1630 may be various types of electronic devices as described above.

The communication network 1620 may be implemented regardless of an aspect of communication such as wired/wireless communication, and may be implemented by various communication networks including a PAN, a LAN, a MAN, a WAN and the like. Further, the communication network 1620 may be a known WWW, and may use a wireless transmission technology utilized for short distance communication such as IrDA or Bluetooth. In addition, the communication network 1620 may include a cable broadcasting communication network, a terrestrial broadcasting communication network, and a satellite broadcasting communication network for receiving a broadcasting signal by the user device 1630.

The user device 1630 that receives an emergency disaster message from the emergency information providing server 1610 through the communication network 1620 analyzes the received emergency disaster message and changes one or more settings of the user device 1630 based on the analyzed content according to an embodiment of the present disclosure. In the following description, the user device 1630 is described as an electronic device.

FIG. 17 is a block diagram of an electronic device 1700 according to an embodiment of the present disclosure.

Referring to FIG. 17, the electronic device 1700 according to an embodiment of the present disclosure may include a communication unit 1710, a display unit 1720, a control unit 1730, and a storage unit 1740.

The communication unit 1710 receives an emergency disaster message from the emergency information providing server 1610 and provides the received emergency disaster message to the control unit 1730.

The control unit 1730 may generate the received emergency disaster message as a pop-up window through the display unit 1720 or may not display the received emergency disaster message according to an embodiment of the present disclosure. The control unit 1730 may include a message analysis unit 1731, a mode switching processing unit 1732 and a setting change window generation unit 1733.

The message analysis unit 1731 performs a function of analyzing the content contained in the emergency disaster message received through the communication unit 1710 and determining whether the emergency disaster message is urgent. The message analyzing method may use a method of parsing the message and extracting one or more keywords included in the message.

For example, since the emergency disaster message includes at least one piece of disaster type information, the information related to a time of the disaster, the information related to the distance to a disaster region, and the information related to a level of disaster as described above, the analysis may be more effectively performed by considering such a fact.

For example, if the emergency disaster message includes the content such as “An earthquake with magnitude 5 took place in Suwon,” information including “Suwon,” “magnitude,” and “earthquake” is extracted through a message analysis by the message analysis unit 1731.

Further, like the above message, if the content of a message contains the term “earthquake”, the message is highly likely to include the term “intensity.” Accordingly, the term “intensity N” is searched for and extracted, and then it may be determined whether to set the emergency mode based on the extracted value of N.

In another example, if the emergency disaster message includes the content such as “A tsunami occurred in an area 20 km off the coast of Incheon,” information including “Incheon,” “off the coast,” “20 km” and “tsunami” is extracted through a message analysis by the message analysis unit 1731. Then, if the content of the message contains the term “tsunami,” the message is highly likely to include a distance from a tsunami occurrence spot. Accordingly, the term “N km” is searched for and extracted, and then it may be determined whether to set the emergency mode based on the extracted value of N. In addition, the above described examples are only examples of the present disclosure, and may be modified by any other methods.

As described above, the message analysis unit 1731 may analyze the received emergency disaster message to determine whether the emergency disaster message is urgent according to a disaster type or determine an urgent level.

The mode switching processing unit 1732 may switch a mode of the electronic device 1700 to a warning mode or an emergency mode according to the emergency level determined by the message analysis unit 1731. In addition, the mode may be switched to one mode (for example, an emergency mode) according to an embodiment of the present disclosure or may be switched to two or more modes such as an alarm mode and an emergency mode according to an embodiment of the present disclosure.

If the mode is set to two or more modes, the settings according to the respective modes may be different, and each of a plurality of modes may be changed in stages according to the emergency level through the message analysis.

Hereinafter, although the description below of an embodiment of the present disclosure describes an example in which a mode is switched to two modes such as the alarm mode and the emergency mode in stages, the present disclosure is not limited thereto.

For example, if the emergency level is lower than a preset reference or the disaster level is not included in the message based on the message analysis, the mode may be set as the alarm mode through an alarm mode switching unit 1732a. Further, if the emergency level exceeds the preset reference or satisfies a particular condition in the alarm mode, the mode may be set to be switched to the emergency mode by an emergency mode switching unit 1732b. Detailed embodiments thereof are described below.

As described above, if the mode of the electronic device 1700 is switched by the mode switching processing unit 1732, a screen display setting of the display unit 1720 may be changed or various settings of the electronic device 1700 may be changed according to the corresponding setting mode.

For example, if the mode is switched to the alarm mode, the alarm mode switching unit 1732a may display a state of the alarm mode of the electronic device 1700 in a flag form and then determine each situation to switch the mode to the emergency mode. In addition, the alarm mode may be set to be switched to the emergency mode by a user, and the usage of some applications may be limited in the alarm mode. Detailed examples of the alarm mode are described below.

In addition, if the mode is switched to the emergency mode, the emergency mode switching unit 1732b may restrict the remaining functions except for minimum functions necessary for the electronic device 1700 in order to minimize power consumed by the electronic device 1700. For example, the emergency mode switching unit 1732b may switch other functions except for a function related to message reception to be in a disabled state. Further, the screen displayed on the display unit 1720 may be switched to a power saving mode in which minimum power is consumed.

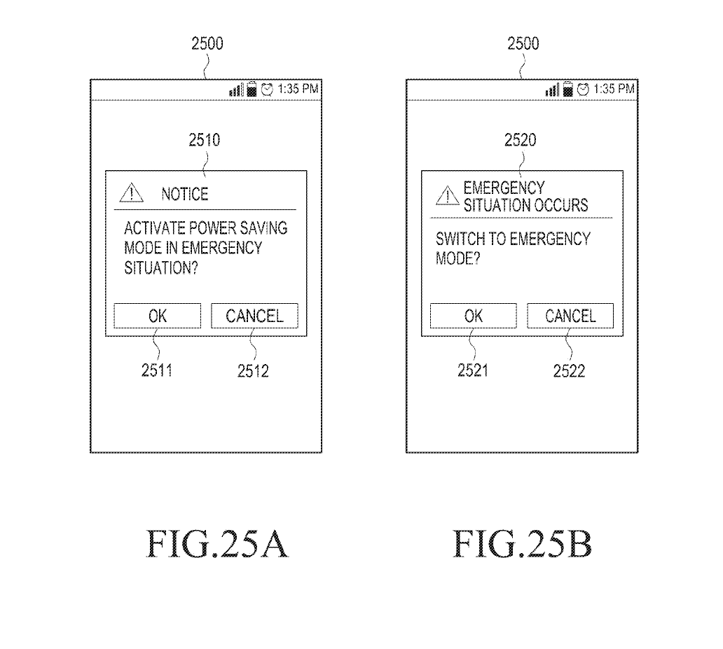

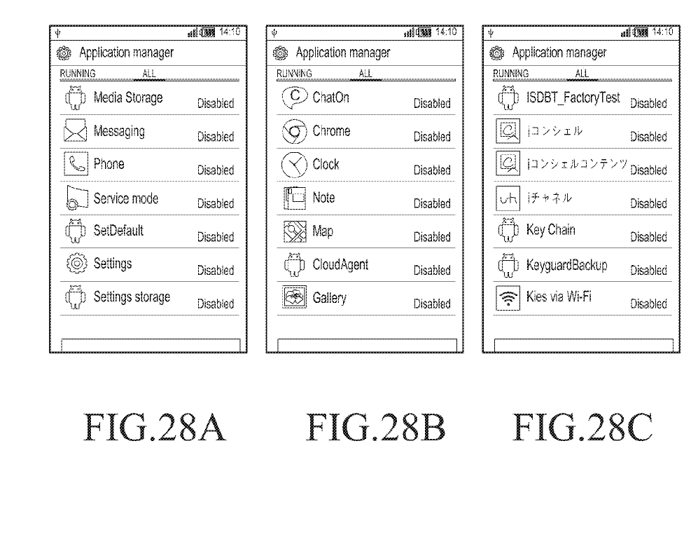

The setting change window generation unit 1733 may perform a function of generating a setting change window (for example, FIG. 25A) for setting a mode switching function according to the emergency situation or generating a function setting change window (for example, FIG. 25B) for switching each mode. According to an embodiment of the present disclosure, if the mode of the electronic device 1700 is switched to the emergency mode and thus applications installed in the electronic device 1700 are switched to be in the disabled state, the setting change window generation unit 1733 may generate a setting change window for switching a particular application to be in an enabled state by a user as illustrated in FIG. 28A to 28C.

The storage unit 1740 may store information such as data and application data required for providing functions according to an embodiment of the present disclosure, and also emergency mode condition information, current mode information, and received emergency disaster message information set according to an embodiment of the present disclosure.

In addition, elements of the electronic device 1700 are separately illustrated to indicate that they may be functionally and logically separated from each other, but the elements do not have to be separate elements or separate code.

Further, in the present disclosure, each function unit may refer to a functional or structural combination of hardware for realizing the technical idea of the present disclosure and software for driving the hardware. For example, each function unit may refer to a logical unit of a predetermined code or a hardware resource for executing the predetermined code, and it may be easily inferred by those skilled in the art that the function unit does not necessarily refer to a physically connected code or one type of hardware.

Hereafter, mode switching processes according to various embodiments of the present disclosure will be described in detail with reference to FIGS. 18 to 22.

FIG. 18 is a flowchart of a method of a mode switching process by an emergency disaster message according to an embodiment of the present disclosure.

Referring to FIG. 18, if an electronic device receives an emergency disaster message in step 1802, the electronic device analyzes the received emergency disaster message in step 1804.

If the emergency disaster message satisfies a condition for switching to the emergency mode based on a result of the analysis in step 1806, the setting of the electronic device is changed to the emergency mode in step 1808. Then, the electronic device may automatically switch to the emergency mode in accordance with satisfying the condition, or may generate a pop-up window for asking whether to switch to the emergency mode and then switching to the emergency mode based on a selection by a user according to other embodiments of the present disclosure described below.

In addition, if the emergency disaster message satisfies a condition for switching to the warning mode in step 1810, the setting of the electronic device is changed to the warning mode in step 1812. Then, the electronic device may automatically switch to the warning mode in accordance with satisfying the condition, or may generate a pop-up window for asking whether to switch to the warning mode and then switching to the warning mode based on a selection by a user according to other embodiments of the present disclosure described below.

In addition, if the emergency disaster message does not satisfy both the emergency mode condition and the warning mode condition based on the result of the analysis, the electronic device may maintain a current mode in step 1814.

The emergency mode switching condition and the warning mode switching condition may be set in various ways. For example, if the emergency disaster message is received, the electronic device may be configured to automatically switch to the warning mode by default. If a danger degree exceeds a preset reference through an analysis of the message, the electronic device may be configured to further switch to the emergency mode. Further, in another example, if the emergency disaster message is received, the electronic device may be configured to switch to the warning mode or the emergency mode according to a danger degree through an analysis of the message.

As described above, according to an embodiment of the present disclosure, if the corresponding mode switching condition is satisfied, the electronic device may be configured to automatically switch or may be configured to generate a pop-up window and switch to the corresponding mode based on a user's selection. According to an embodiment of the present disclosure described below, if there is no user's input for a predetermined time after the pop-up window is generated, the electronic device may be configured to automatically switch to the corresponding mode.

In addition, although FIG. 18 illustrates that the electronic device may switch to the two modes according to the analysis of the received emergency disaster message, the electronic device may switched to one mode (for example, the warning mode) according to other embodiments of the present disclosure as described above, or to three or more modes according to the emergency level. Accordingly, the electronic device may apply the change in the function setting of the electronic device in stages according to each mode.

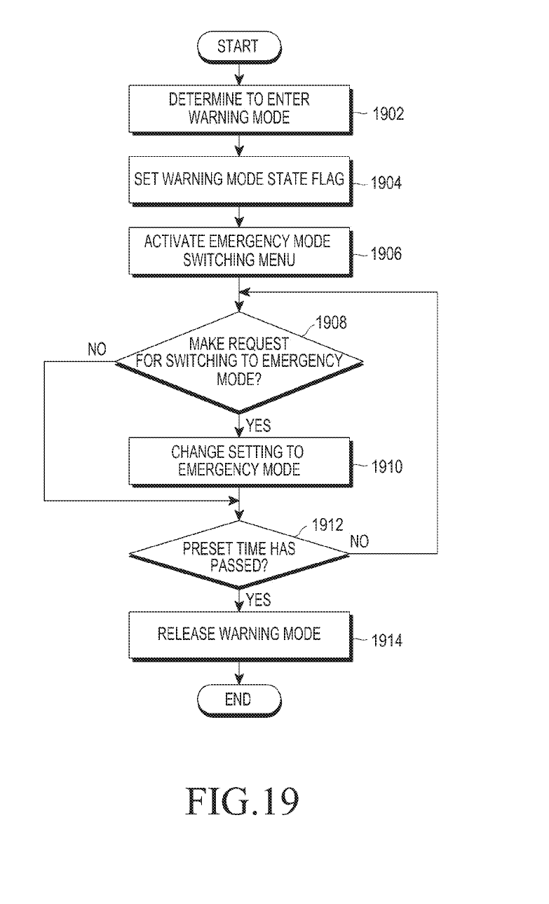

FIG. 19 is a flowchart of a method of an emergency mode switching process according to an embodiment of the present disclosure.

Referring to FIG. 19, if a warning mode switching condition is satisfied as illustrated in FIG. 18 and thus it is determined to enter a warning mode in step 1902, the electronic device may identify that a current state of the electronic device is the warning mode by setting a warning mode state flag in step 1904. Further, the electronic device may change the setting of one or more preset functions among the functions of the electronic device according to the set warning mode. For example, the electronic device may apply in advance some of the function settings to be applied to the emergency mode or may reduce a level of the function settings to be applied to the emergency mode and then apply the reduced function settings (for example, the electronic device may adjust the brightness of a background screen of a touch screen in stages). Further, according to another embodiment of the present disclosure, the electronic device may display the warning mode by setting the warning mode state flag and may not change other function settings.

As described above, if the mode is switched to the warning mode, the electronic device may activate a function of manually switching the mode to the emergency mode. Accordingly, the electronic device may activate an emergency mode switching menu in step 1906, and make a request for switching to the emergency mode through the corresponding emergency mode switching menu in step 1908.

Therefore, the electronic device may switch the mode of the electronic device to the emergency mode according to the emergency mode switching request by a user in step 1910. Then, if there is no switching to the emergency mode or no particular event (for example, reception of another emergency disaster message) for a predetermined time after entering the warning mode in step 1912, the electronic device may release the warning mode automatically or according to a user's input in step 1914.

Further, according to another embodiment of the present disclosure, if another emergency disaster message is received, emergency disaster messages are received by a predetermined number of times after entering the warning mode, or if a warning mode entering condition is satisfied a predetermined number of times, the electronic device may switched to the emergency mode.

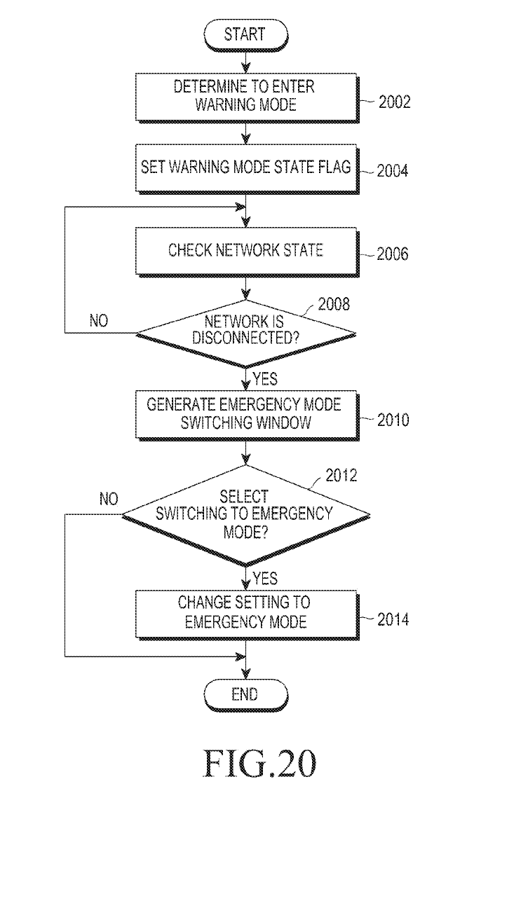

FIG. 20 is a flowchart of a method of an emergency mode switching process according to an embodiment of the present disclosure.

Referring to FIG. 20, if a warning mode switching condition is satisfied as illustrated in FIG. 18 and thus it is determined to enter a warning mode in step 2002, the electronic device may identify that a current state of the electronic device is the warning mode by setting a warning mode state flag in step 2004. Further, the electronic device may change the setting of one or more preset functions among the functions of the electronic device according to the set warning mode. For example, the electronic device may apply in advance some of the function settings to be applied to the emergency mode or may reduce a level of the function settings to be applied to the emergency mode and then apply the reduced function settings (for example, the electronic device may adjust the brightness of a background screen of a touch screen in stages). Further, according to another embodiment of the present disclosure, the electronic device may display the warning mode by setting the warning mode state flag to not be able to change other function settings.

As described above, after switching to the warning mode, the electronic device may not additionally receive an emergency disaster message according to various emergency disaster situations. For example, after receiving an emergency disaster message, the electronic device may not receive an additional emergency disaster message since a communication network is disconnected due to a sudden disaster situation. In this case, even though the mode should be switched to the emergency mode in principle, the electronic device may not perform the mode switching since the message is not received. According to another embodiment of the present disclosure, if the network is disconnected after entering the warning mode, the electronic device may automatically switch to the emergency mode.

For example, after entering the warning mode, the electronic device may check a network state in step 2006 and, if a network disconnection situation occurs (for example, communication with a base station is not possible) in step 2008, may automatically switch to the emergency mode or generate an emergency mode switching window for switching to the emergency mode in step 2010.

If the user selects switching to the emergency mode through the emergency mode switching window in step 2012, the setting of the electronic device may be changed to the emergency mode in step 2014. As described above, apart from the emergency mode setting according to the analysis of the received emergency disaster message, if a certain condition is satisfied in the warning mode according to an embodiment of the present disclosure, the electronic device may switch to the emergency mode without the reception of an additional emergency disaster message.

Accordingly, for example, if the base station is damaged or destroyed due to a sudden disaster and thus communication is not possible before the message for switching to the emergency mode is received, the electronic device may determine that the current situation is in the emergency mode and automatically switch to the emergency mode. Therefore, even though the base station is restored after a predetermined (e.g. long) time, the electronic device may operate for a long time, thereby more effectively providing disaster aid.

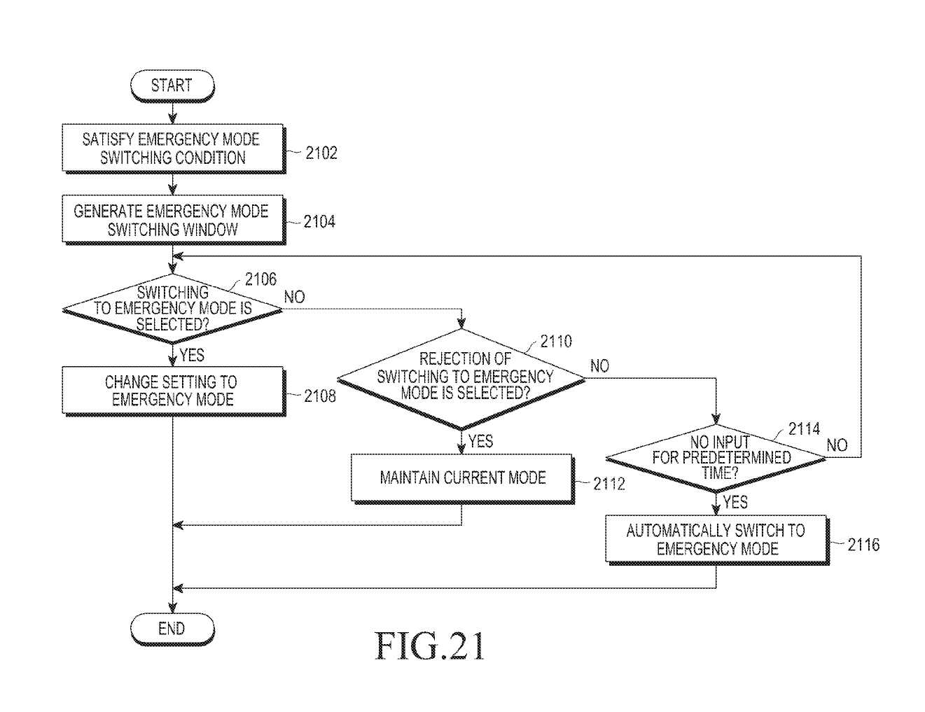

FIG. 21 is a flowchart of a method of an emergency mode switching process according to an embodiment of the present disclosure.

Referring to FIG. 21, as described above, if the emergency mode switching condition is satisfied in step 2102 according to an embodiment of the present disclosure, an electronic device may be automatically switched to the emergency mode or may generate an emergency mode switching window in step 2104 to manually switch to the emergency mode as illustrated in FIG. 25B.

Accordingly, if a user selects switching to the emergency mode through the emergency mode switching window in step 2106, the setting of the electronic device may be changed to the emergency mode in step 2108. In contrast, if switching to the emergency mode is rejected, in step 2110, the electronic device maintains a current mode (for example, the warning mode or the normal mode) in step 2112.

Meanwhile, if there is no user input for a predetermined time with no selection or rejection of the switching to the emergency mode in step 2114, the electronic device may be configured to automatically switch to the emergency mode in step 2116. For example, if the user cannot identify the screen of the electronic device even though the emergency mode switching condition is satisfied, it is highly likely to be an emergency situation. Accordingly, if a non-input state lasts for a predetermined time, the electronic device may automatically switch to the emergency mode as described above.

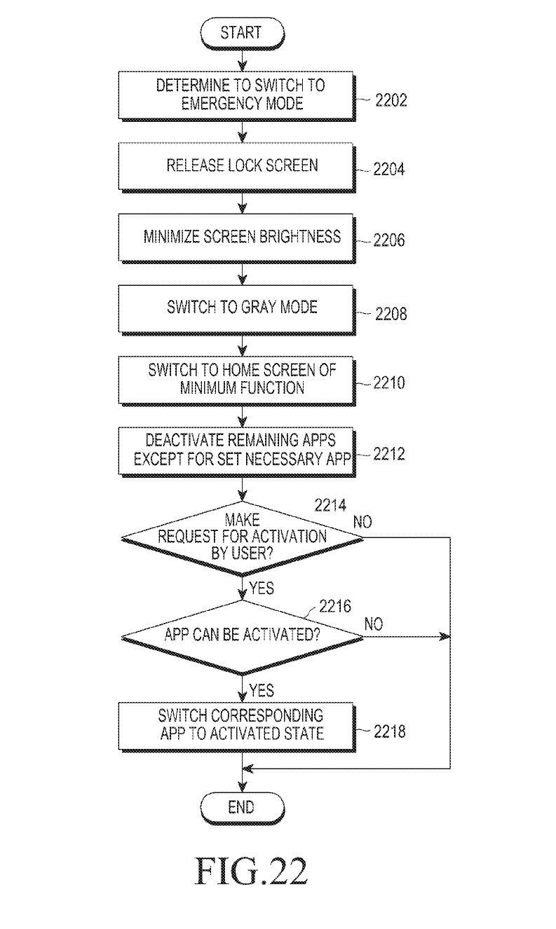

FIG. 22 is a flowchart a method of a setting process performed if switching to an emergency mode according to an embodiment of the present disclosure.

Referring to FIG. 22, if switching to the emergency mode is determined in step 2202 according to the embodiments of FIGS. 18 to 21, it is possible to minimize power consumption by changing the setting of one or more functions among the functions of an electronic device.

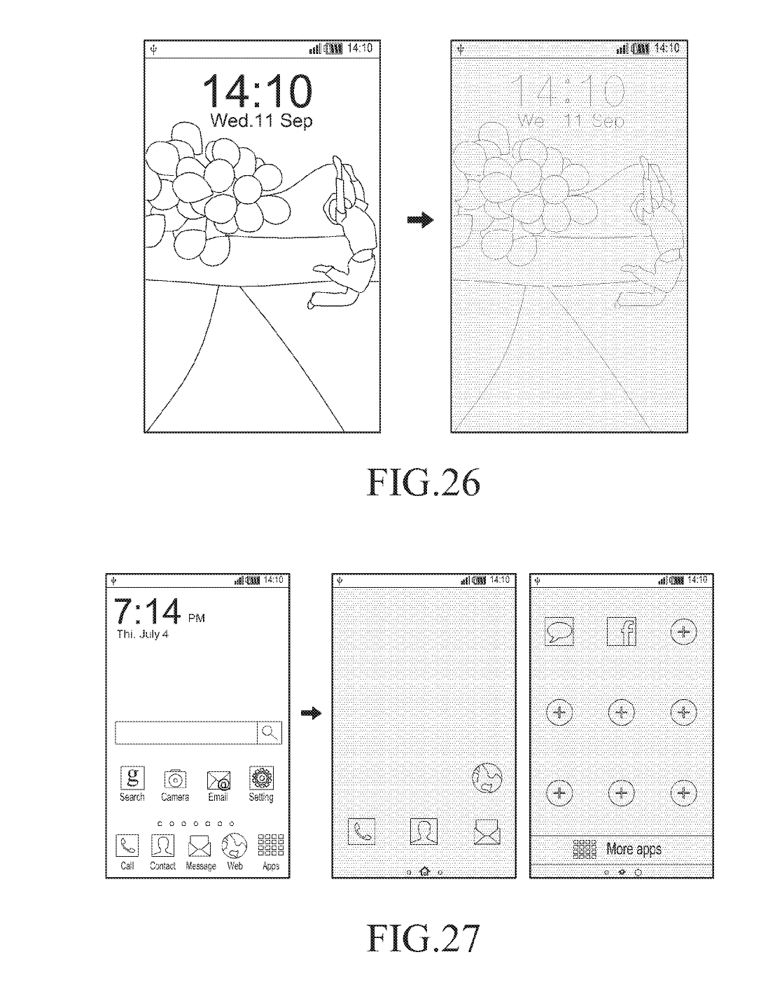

For example, the electronic device may release a lock screen in step 2204, and minimize screen brightness of a display unit of the electronic device in step 2206. Further, as illustrated in FIG. 26, the electronic device may switch the screen of the display unit of the electronic device to a gray mode in step 2208.

In addition, as illustrated in FIG. 27, the electronic device may use only a minimum function by switching a home screen of the electronic device to a home screen of the minimum function in step 2210. Then, the electronic device may minimize power consumption by deactivating the remaining applications except for preset essential applications (for example, a phone call application or app, a message reception app, a web browser, and the like).

In addition, even though all the applications except for the preset essential applications are deactivated as described above, the electronic device may enable a user to manually activate a certain application among the deactivated applications according to an embodiment of the present disclosure.

Accordingly, as illustrated in FIGS. 28A to 28C, if a request is made to activate one or more applications among deactivated applications displayed as “disabled” in an application list in step 2214 of FIG. 22, the electronic device determines whether the corresponding requested application is an application which may be activated in the emergency mode in step 2216. If the application of which the activation is requested by the user is determined to be an application which may be activated in the emergency mode, the corresponding application is switched to an activated state in step 2218. In contrast, if the application of which the activation is requested by the user is determined to not be an application which may be activated in the emergency mode, the corresponding application is maintained in the deactivated state. Then, the deactivated state of the application may be processed to have the same effect generated when the corresponding application is removed. Accordingly, for example, power consumption generated by the operation of the corresponding application in a background of the electronic device may be prevented.

In addition, whether an application may be activated in the emergency mode may be determined in consideration of a degree of the power consumption of the corresponding application. For example, an application having large power consumption such as a game may not be activated even by a user's request, and an application frequently used and having small power consumption such as a messenger may be switched to the deactivated state by default and may be switched to the activated state according to a user's selection.

Further, according to an embodiment of the present disclosure, it is possible to minimize power consumption by allowing the electronic device to not use functions related to various types of communication (for example, network-related functions).

For example, signal reception for a network-related function such as NITZ may be released in the emergency mode. Accordingly, the power consumption may be reduced by not updating network time information from the communication network.

Further, in the emergency mode, the use of mobile data may be limited by removing a mobile data logical path and the corresponding related application may be notified of a disconnected state.

Accordingly, for example, the electronic device may be implemented to not use a push service of a messenger application and, if the electronic device is in a Screen On state, may notify of message reception information.

Further, in the emergency mode, registration of an alarm manager 3rd party application service may be limited. Accordingly, the use of a background service of the corresponding application may be limited.

In the emergency mode, the electronic device may be implemented to remain in a sleep state without waking up a CPU of the electronic device according to an embodiment of the present disclosure.

In addition, one or more of the methods of restricting various functions to reduce power consumption may be selectively applied in the emergency mode according to an embodiment of the present disclosure as described above, and methods other than the above described methods which may minimize the power consumption of the electronic device may be applied to the emergency mode of the present disclosure.

Meanwhile, methods of displaying states of the electronic device according to various embodiments of the present disclosure may be implemented in a form of a program command which may be executed through various computer means and may be recorded in a non-transitory computer-readable recording medium. The non-transitory computer-readable recording medium may include a program command, a data file, and a data structure separately or in combination. The program command recorded in the non-transitory computer recording medium may be designed and configured for the present disclosure, or may be known to those skilled in the related art. Examples of the non-transitory computer-readable recording medium include magnetic media such as hard disks, floppy disks and magnetic tapes, optical media such as a CD-ROM and a digital versatile disc (DVD), magneto-optical media such as floppy disks, and hardware devices such as a ROM, a RAM and a flash memory, which are configured to store and perform the program command. Examples of the program command include a machine language code generated by a compiler and a high-level language code executable by a computer through an interpreter and the like. The hardware devices may be configured to operate as one or more software modules to perform the operations of the present disclosure, and vice versa.

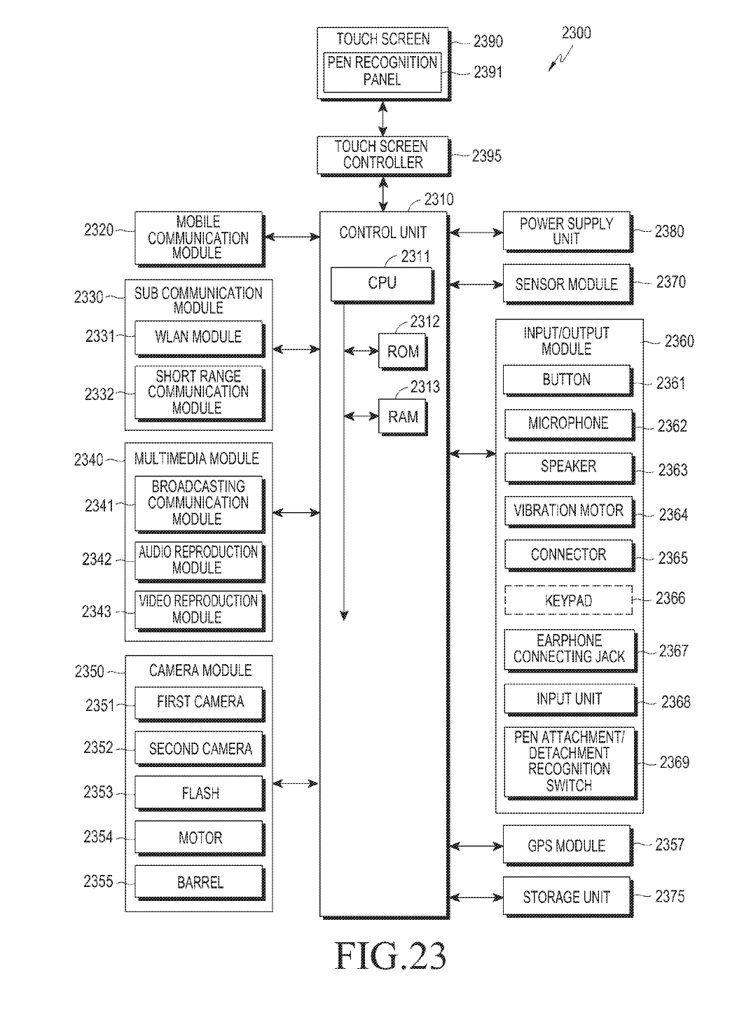

Further, as described above, setting changes of various functions (for example, function restriction) in the emergency mode may be selected from various functions of the electronic device according to an embodiment of the present disclosure. An example of an electronic device having various functions is described below in detail with reference to FIG. 23, where the electronic device may be a smartphone.

FIG. 23 is a block diagram of an electronic device according to an embodiment of the present disclosure.

Referring to FIG. 23, an electronic device 2300 may include at least one control unit 2310, a mobile communication module 2320, a multimedia module 2340, a camera module 2350, an input/output module 2360, a sensor module 2370, a storage unit 2375, a power supply unit 2380, and a touch screen 2390.

In addition, the electronic device 2300 may be connected to an external electronic device by using at least one of the mobile communication module 2320, a connector 2365, and an earphone connecting jack 2367. In addition, the electronic device 2300 may be connected to another portable device or another electronic device, for example, one of a mobile phone, a smartphone, a tablet PC, a desktop PC, and a server through a wire or wirelessly.

The mobile communication module 2320 may include a sub communication module 2330, and a broadcasting communication module 2341. The sub communication module 2330 may include at least one of a WLAN module 2331 and a short range communication module 2332. The multimedia module 2340 may include the broadcasting communication module 2341, an audio reproduction module 2342, and a video reproduction module 2343. The camera module 2350 may include at least one of a first camera 2351 and a second camera 2352. Further, the camera module 2350 may further include a flash 2353, a motor 2354, and a barrel (e.g. a camera barrel) 2355. The input/output module 2360 may include at least one of a button 2361, a microphone 2362, a speaker 2363, a vibration motor 2364, the connector 2365, and a keypad 2366.

The control unit 2310 may include a CPU 2311, a ROM 2312 that stores a control program for controlling the electronic device 2300, and a RAM 2313 that is used as a storage area for storing a signal or data input from the outside of the electronic device 2300 or for work performed in the electronic device 2300. The CPU 2311 may include a single core, a dual core, a triple core, or a quadruple core. The CPU 2311, the ROM 2312, and the RAM 2313 may be mutually connected to each other through an internal bus.

The control unit 2310 may control at least one of the mobile communication module 2320, the multimedia module 2340, the camera module 2350, the input/output module 2360, the sensor module 2370, the storage unit 2375, the power supply unit 2380, the touch screen 2390, and a touch screen controller 2395.

The control unit 2310 may determine whether to switch to the emergency mode by analyzing an emergency disaster message received through the mobile communication module 2320 according to an embodiment of the present disclosure.

In addition, if the control unit 2310 determines to switch to the emergency mode or the warning mode, the control unit 2310 may minimize power consumption by controlling each function unit controlled by the control unit 2310 or functions of the modules.

Further, the control unit 2310 may detect a user input event such as a hovering event as an input unit 2368 approaches the touch screen 2390 or is located close to the touch screen 2390. In addition, the control unit 2310 may detect various user inputs received through the camera module 2350, the input/output module 2360, and the sensor module 2370 as well as the touch screen 2390. The user input may include various types of information input into the device 2300 such as a gesture, a voice, a pupil action, an iris recognition, and a biometric signal of the user as well as a touch. The control unit 2310 may control a predetermined operation or function corresponding to the detected user's input to be performed within the device 2300. Further, the control unit 2310 may output a control signal to the input unit 2368 or the vibration motor 2364. The control signal may include information on a vibration pattern and the input unit 2368 or the vibration motor 2364 may generate a vibration according to the vibration pattern.

The electronic device 2300 may include at least one of the mobile communication module 2320, the WLAN module 2331, and the short range communication module 2332 according to the performance thereof.

The mobile communication module 2320 may connect the electronic device 2300 to an external device through mobile communication by using at least one antenna or a plurality of antennas under control of the control unit 2310. The mobile communication module 2320 may transmit/receive a radio signal for a voice call, a video call, a short message service (SMS), or a multimedia messaging service (MMS) to/from a mobile phone, a smartphone, a tablet PC, or another electronic device having a phone number input into the electronic device 2300. Further, according to an embodiment of the present disclosure, an emergency disaster message transmitted from the emergency information providing server may be received through the mobile communication module 2320.

The sub communication module 2330 may include at least one of the WLAN module 2331 and the short range communication module 2332. For example, the sub-communication module 2330 may include only the WLAN module 2331, only the short range communication module 2332, or both the WLAN module 2331 and the short range communication module 2332.

The WLAN module 2331 may be connected to the Internet in a place where a wireless access point (AP) is installed according to a control of the control unit 2310. The WLAN module 2331 may support a WLAN standard of the Institute of Electrical and Electronics Engineers (IEEE) (e.g. IEEE802.11x)). The short range communication module 2332 may wirelessly perform short range communication between the electronic device 2300 and an external electronic device under control of the control unit 2310. A short range communication scheme may include Bluetooth, an IrDA communication standard, WiFi-Direct communication, near field communication (NFC) and the like.

The broadcasting communication module 2341 may receive a broadcasting signal (for example, a TV broadcasting signal, a radio broadcasting signal, or a data broadcasting signal) and broadcasting supplement information (for example, an electronic programming guide (EPG) or electronic service guide (ESG)) output from a broadcasting station through a broadcasting communication antenna under control of the control unit 2310.

The multimedia module 2340 may include the audio reproduction module 2342 or the video reproduction module 2343. The audio reproduction module 2342 may reproduce a digital audio file (for example, a file having a file extension of mp3, wma, ogg, or way) stored or received in the storage unit 2375 under control of the control unit 2310. The video reproduction module 2343 may reproduce a digital video file (for example, a file having a file extension of mpeg, mpg, mp4, avi, mov, or mkv) stored or received under control of the control unit 2310. The multimedia module 2340 may be integrated in the control unit 2310.

The camera module 2350 may include at least one of the first camera 2351 and the second camera 2352 that photograph a still image, a video, or a panorama picture under control of the control unit 2310. Further, the camera module 2350 may include at least one of the barrel 2355 for performing zoom-in/out for photographing a subject, the motor 2354 for controlling a movement of the barrel 2355, and the flash 2353 for providing an auxiliary light source required for photographing the subject. The first camera 2351 may be disposed on a front surface of the electronic device 2300, and the second camera 152 may be disposed on a rear surface of the electronic device 2300.

The input/output module 2360 may include at least one of at least one button 2361, at least one microphone 2362, at least one speaker 2363, at least one vibration motor 2364, the connector 2365, the keypad 2366, the earphone connecting jack 2367, and the input unit 2368. The input/output module 2360 may provide a mouse, a trackball, a joystick, or a cursor control such as cursor direction keys to control a movement of a cursor on the touch screen 2390.

The button 2361 may be formed on a front surface, a side surface, or a rear surface of a housing (or case) of the electronic device 2300, and may include at least one of a power/lock button, a volume button, a menu button, a home button, a back button, and a search button. The microphone 2362 may receive a voice or a sound to generate an electrical signal under control of the control unit 2310. The speaker 2363 may output sounds corresponding to various signals or data (for example, wireless data, broadcasting data, digital audio data, digital video data and the like) external to the electronic device 2300 under control of the control unit 2310. The speaker 2363 may output a sound (for example, a button tone corresponding to a phone communication, a ring tone, and a voice of another user) corresponding to a function performed by the electronic device 2300. At least one speaker 2363 may be formed at a suitable position or positions of the housing of the electronic device 2300.

The vibration motor 2364 may convert an electrical signal to a mechanical vibration under control of the control unit 2310. For example, if the electronic device 2300 in a vibration mode receives a voice call from another device, the vibration motor 2364 operates. At least one vibration motor 2364 may be formed within the housing of the electronic device 2300. The vibration motor 2364 may operate in accordance with a user's input through the touch screen 2390.

The connector 2365 may be used as an interface for connecting the electronic device 2300 with an external electronic device or a power source. The control unit 2310 may transmit or receive data stored in the storage unit 2375 of the electronic device 2300 to or from an external electronic device through a wired cable connected to the connector 2365. The electronic device 2300 may receive power from a power source through the wired cable connected to the connector 2365 or charge a battery by using the power source.

The keypad 2366 may receive a key input from a user to control the electronic device 2300. The keypad 2366 may include a physical keypad formed in the electronic device 2300 or a virtual keypad displayed on the touch screen 2390. The physical keypad formed in the electronic device 2300 may be excluded according to the performance or a structure of the electronic device 2300. Earphones may be inserted into the earphone connecting jack 2367 to be connected to the electronic device 2300.

The input unit 2368 may be inserted in the electronic device 2300 and withdrawn or separated from the electronic device 2300 when being used. A pen attachment/detachment recognition switch 2369, which operates in accordance with an installation and attachment/detachment of the input unit 2368, is located in an area within the electronic device 2300 into which the input unit 2368 is inserted, and the pen attachment/detachment recognition switch 2369 may output signals corresponding to the installation and separation of the input unit 2368 to the control unit 2310. The pen attachment/detachment recognition switch 2369 may be configured to directly/indirectly contact the input unit 2368 if the input unit 2368 is mounted. Accordingly, the pen attachment/detachment recognition switch 2369 may generate a signal corresponding to the installation or the separation of the input unit 2368 (that is, signal informing of the installation or the separation of the input unit 2368) and output the generated signal to the control unit 2310 based on whether the pen attachment/detachment recognition switch 2369 contacts the input unit 2368.

The sensor module 2370 includes at least one sensor for detecting a state of the electronic device 2300. For example, the sensor module 2370 may include at least one of a proximity sensor for detecting whether a user approaches the electronic device 2300, an illuminance sensor for detecting an amount of ambient light surrounding the electronic device 2300, a motion sensor for detecting a motion (for example, a rotation, an acceleration, or a vibration) of the electronic device 2300, a geo-magnetic sensor for detecting a point of a compass by using the Earth's magnetic field, a gravity sensor for detecting the direction of a gravitational force, an altimeter for measuring an atmospheric pressure to detect an altitude, and a global positioning system (GPS) module 2357.

The GPS module 2357 may receive radio waves from a plurality of GPS satellites in Earth's orbit and calculate a position of the electronic device 2300 by using time of arrival from the GPS satellites to the electronic device 2300.

The storage unit 2375 may store a signal or data input/output according to an operation of the communication module 2320, the multimedia module 2340, the camera module 2350, the input/output module 2360, the sensor module 2370, or the touch screen 2390. Further, according to an embodiment of the present disclosure, the storage unit 2375 may store various piece of state information and setting information on the electronic device 2300.

The storage unit 2375 may store a control program and applications for controlling the electronic device 2300 or the control unit 2310. One of the control program and the applications may analyze a received emergency message according to an embodiment of the present disclosure, change a setting to a corresponding mode according to the analysis of the received emergency message, and change preset functions according to each mode.

The term “storage unit” refers to a predetermined data storage device such as the storage unit 2375, the ROM 2312 or the RAM 2313 within the control unit 2310, or a memory card (for example, an SD card or a memory stick) installed in the electronic device 2300. The storage unit 2375 may also include a non-volatile memory, a volatile memory, an HDD, or an SSD.

Further, the storage unit 2375 may store applications having various functions such as a navigation function, a video call function, a game function, and a time based alarm function, images for providing a GUI related to the applications, databases or data related to a method of processing user information, a document, a touch input, background images (a menu screen, an idle screen or the like), operating programs required for driving the electronic device 2300, and images photographed by the camera module 2350.

The storage unit 2375 is a non-transitory machine readable recording medium (for example, a non-transitory computer-readable recording medium). The term “non-transitory machine-readable recording medium” may be defined as a non-transitory medium capable of providing data to a machine so that the machine performs a certain function. The storage unit 2375 may include a non-volatile medium and a volatile medium. All of these media may be tangible such that the commands transferred by the media may be detected by a physical instrument such as the machine reading the commands.

The non-transitory machine-readable recording medium includes at least one of a floppy disk, a flexible disk, a hard disk, a magnetic tape, a CD-ROM, an optical disk, a punch card, a paper tape, a RAM, a PROM, an EPROM, a flash-EPROM, and an embedded multi media card (eMMC), but the present disclosure is not limited thereto.

The power supply unit 2380 may supply power to at least one battery arranged in a housing of the electronic device 2300 under control of the control unit 2310. The at least one battery supplies power to the electronic device 2300. Further, the power supply unit 2380 may supply power input from an external power source through a wired cable connected to the connector 2365 to the electronic device 2300. In addition, the power supply unit 2380 may supply power wirelessly input from the external power source through a wireless charging technology to the electronic device 2300.

The electronic device 2300 may include at least one touch screen 2390 providing GUIs corresponding to various services (for example, a phone call, data transmission, broadcasting, and photography) to a user. The touch screen 2390 may output an analog signal corresponding to at least one user input which is input to a GUI to the touch screen controller 2395.

The touch screen 2390 may receive at least one user input through a user's body (for example, fingers including a thumb) or the input unit 2368 (for example, a stylus pen or an electronic pen). The touch screen 2390 may be implemented in a resistive type touch screen, a capacitive type touch screen, an infrared type touch screen, an acoustic wave type touch screen, or a combination thereof.

Further, the touch screen 2390 may include at least two touch panels which may detect touches or approaches of a finger and the input unit 2368, respectively, in order to receive inputs of the finger and the input unit 2368, respectively. The two or more touch panels provide different output values to the touch screen controller 2395. Then, the touch screen controller 2395 may recognize the different values input to the two or more touch panels to distinguish whether the input from the touch screen 2390 is an input by a finger or an input by the input unit 2368.

In addition, a touch is not limited to a touch between the touch screen 2390 and a user's body or touchable input means, but includes a non-contact (for example, a case where an interval between the touch screen 2390 and a user's body or touchable input means is 1 mm or less). The detectable interval of the touch screen 2390 may be changed according to the performance or structure of the electronic device 2300.

The touch screen controller 2395 converts an analog signal received from the touch screen 2390 into a digital signal and transmits the converted digital signal to the control unit 2310. The control unit 2310 may control the touch screen 2390 by using the digital signal received from the touch screen controller 2395. The touch screen controller 2395 may identify a hovering interval or distance as well as a position of the user input by detecting a value (for example, a current value or the like) output through the touch screen 2390, and convert the identified distance value to a digital signal (for example, a z-axis coordinate), and provide the converted digital signal to the control unit 2310. Further, the touch screen controller 2395 may detect a pressure applied to the touch screen 2390 by the user input means by detecting the value (for example, the current value or the like) output through the touch screen 2390, convert the detected value to a digital signal, and then provide the converted digital signal to the control unit 2310.

In addition, according to an embodiment of the present disclosure, the control unit 2310 may display a screen with a sleep mode which may minimize power consumption by controlling the touch screen 2390.

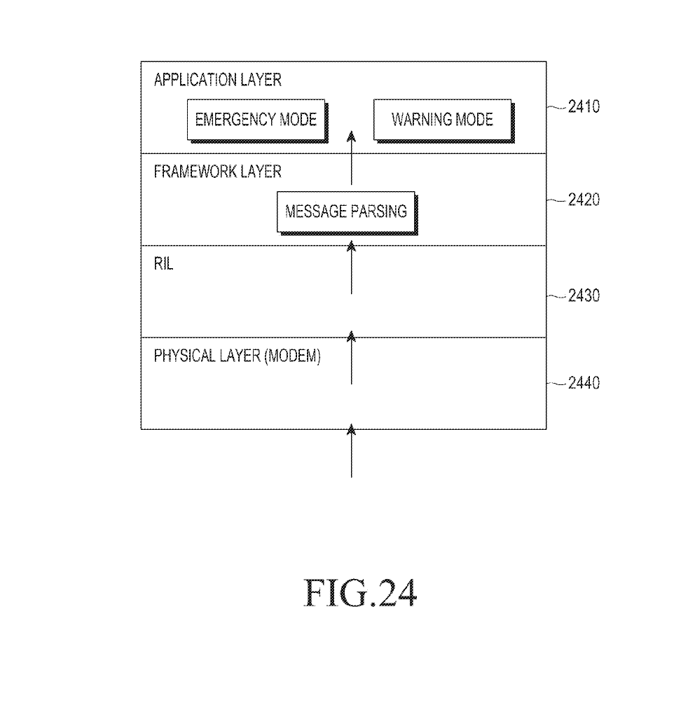

FIG. 24 illustrates layers for processing a received emergency disaster message according to an embodiment of the present disclosure.

Referring to FIG. 24, with respect to an emergency disaster message received through an antenna, a physical layer 2440 performs physical layer signal processing and a radio interface layer (RIL) 2430 performs radio signal processing.

In addition, according to the embodiment of the present disclosure, a framework layer 2420 may perform a message analysis of a received emergency disaster message. For example, it may be determined whether to switch to an emergency related mode by extracting words included in the message through a syntax analysis (e.g. message parsing) and analyzing a correlation between the words in association with a disaster.

According to the message parsing by the framework layer 2420, the application layer 2410 switches the mode to the warning mode or the emergency mode according to an embodiment of the present disclosure and performs corresponding preset functions.

Hereinafter, various embodiments implemented to set an emergency situation in the electronic device are described with reference to FIGS. 25A to 28C.

FIG. 25A illustrates a screen configuration for setting an emergency mode switching window in an electronic device according to an embodiment of the present disclosure.

Referring to FIG. 25A, a user may allow mode switching for an emergency situation in the electronic device. Accordingly, if a display unit 2500 of the electronic device displays a mode setting window 2510 for setting the emergency situation, the user may select a corresponding function. For example, if the user selects “OK” 2511, a mode switching function may be provided if the emergency disaster message is received according to an embodiment of the present disclosure. In contrast, if the user selects “CANCEL” 2512, the corresponding function is not used and the mode switching may not be performed even though the emergency disaster message is received.

FIG. 25B illustrates a screen configuration of an emergency mode switching window in an electronic device according to an embodiment of the present disclosure.

Referring to FIG. 25B, a user may manually set the emergency mode in the electronic device. For example, if the emergency mode switching condition is satisfied as described above, the user may directly switch the mode as illustrated in FIG. 25B, or the user may generate a window through a menu for window generation in the warning mode.

Accordingly, if the display unit 2500 of the electronic device displays a setting window 2520 for determining whether to switch to the emergency mode, the user may manually select an emergency mode switching function. For example, if the user selects “OK” 2521, the electronic device may directly switch to the emergency mode according to an embodiment of the present disclosure and thus set various functions according to the set emergency mode. In contrast, if the user selects “CANCEL” 2522, the electronic device may not switch to the emergency mode even though the emergency mode condition is satisfied. Accordingly, the previous mode (for example, a warning mode or a normal mode) is maintained.

In addition, as described above with reference to FIG. 21, if there is no selection in the emergency mode setting window 2520 for a predetermined time, the electronic device may consider this situation as the emergency situation and automatically switch to the emergency mode according to an embodiment of the present disclosure.

FIG. 26 illustrates a screen configuration based on a setting of an emergency situation in an electronic device according to an embodiment of the present disclosure.

Referring to FIG. 26, if the electronic device switches to the warning mode or the emergency mode according to an embodiment of the present disclosure, it is possible to reduce power consumption by switching the screen of the display unit of the electronic device to a black and white screen and reducing a resolution or brightness of the screen.

FIG. 27 illustrates an example where an electronic device changes a home screen configuration according to an emergency mode setting according to an embodiment of the present disclosure.

Referring to FIG. 27, if the electronic device switches to the emergency mode according to an embodiment of the present disclosure as described above, the electronic device may provide a home screen dedicated for the emergency mode in which all applications or functions except for a minimum function are removed from the home screen. Accordingly, the power consumption may be minimized in the emergency mode.

Further, as illustrated in a right side of FIG. 27, the remaining installed applications except for a preset minimum application may be deactivated in an application screen. Then, if a user desires to additionally activate an application according to an embodiment of the present disclosure as described above, an activation/deactivation setting of each application may be changed in the application setting screen as illustrated in FIG. 28A to 28C.

FIGS. 28A to 28C illustrate a deactivated application according to an emergency mode setting in an electronic device according to an embodiment of the present disclosure.

Referring to FIGS. 28A to 28C, among applications displayed as deactivated applications on the application setting screen, an application which a user desires to use may be activated. However, as described above, an application may not be activated in the emergency mode in order to minimize power consumption as described above.

As described above, the present disclosure has been described by certain matters such as detailed elements, limited embodiments, and accompanying drawings, but they are provided only to assist general understanding of the present disclosure, and the present disclosure is not limited by the embodiments and may be variously modified and changed by those skilled in the art from such disclosure.

Accordingly, the present disclosure is not intended to be defined by the aforementioned embodiments. While embodiments of the present disclosure have been described above, those skilled in the art will readily appreciate that many modifications are possible without materially departing from the novel teachings and advantages. Accordingly, all such modifications are intended to be included within the scope of the present disclosure as defined by the appended claims and their equivalents.

1. A method of performing a power saving mode in an electronic device, the method comprising:
driving at least one processor;
detecting a command for switching to a power saving mode; and
if the command for switching to the power saving mode is detected, limiting operations of the at least one processor to block set functions other than a power saving call function in accordance with at least one set power saving scheme.

2. The method of claim 1, further comprising, if the command for switching to the power saving mode is an emergency message received externally:
extracting at least one piece of disaster-related information by parsing the emergency message; and
switching to an emergency mode based on the extracted disaster-related information.

3. The method of claim 1, further comprising, if the command for switching to the power saving mode is detected, displaying a screen configured to use at least one of a control of brightness of a screen of a display unit, of switch the screen of the display unit to a gray mode, switch a home screen of the display unit to a home screen of a minimum function, and deactivate other applications except for a set necessary applications.

4. The method of claim 3, wherein the set necessary application includes at least one of a phone call application, a message application, and a web browser application.

5. The method of claim 1, wherein the at least one processor includes at least one of a call processor (CP) and an application processor (AP).

6. The method of claim 1, wherein the command for switching to the power saving mode is one of a request for switching a mode by a user and a reception of an emergency message from a cell broadcast message service (CBS) server or an earthquake and tsunami warning service (ETWS) server through a mobile communication protocol.

7. The method of claim 1, further comprising, if the at least one of the set power saving schemes is a network limiting scheme for limiting transmission of information based on a network, fixing a network function (NAT) by a call processor (CP) in order to increase a sleep period of a modem or blocking transmission of network information received from the network to an application processor (AP) by the CP if a screen is turned off.

8. The method of claim 1, further comprising, if the at least one of the set power saving schemes is a network limiting scheme for limiting transmission of information based on a network:
deleting a route table to block mobile data transmission/reception between an application processor (AP) and a call processor if a screen is turned off; and
if the turned off screen is subsequently turned on, reconstructing the route table.

9. The method of claim 1, further comprising, if the at least one the set power saving scheme is a process limiting scheme for limiting the use of a background in a screen off state:
halting a process in application processor (AP) if the screen is turned off; and
if the turned off screen is subsequently turned on, performing the process.

10. An electronic device for performing a power saving mode, the electronic device comprising:
a display unit configured to display a power saving screen if a command for switching to a power saving mode is detected, the display unit is functionally connected to the electronic device; and
a control unit comprising a call processor (CP) configured to control a power saving call-related function and an application processor that controls other functions except for the power saving call-related function,
wherein the control unit is configured to control to limit an operation of at least one of the call processor (CP) and the application processor (AP) to block at least some of the other functions in accordance with at least one set power saving scheme if the command for switching to the power saving mode is detected.

11. The electronic device of claim 10, wherein, if the command for switching to the power saving mode is an emergency message received externally, the control unit is configured to parse the emergency message to extract at least piece of disaster-related information and switch to an emergency mode based on the extracted disaster-related information.

12. The electronic device of claim 11, wherein the set necessary application includes at least one of a phone call application, a message application, and a web browser application.

13. The electronic device of claim 10, further comprising a power saving screen configured to use at least one of a control of brightness of a screen of a display unit, switch screen of the display unit to a gray mode, switch a home screen of the display unit to a home screen of a minimum function, and deactivate another application except for a set necessary applications.

14. The electronic device of claim 10, wherein the command for switching to the power saving mode is one of a request for switching a mode by a user and a reception of an emergency message from a cell broadcast message service (CBS) server or an earthquake and tsunami warning service (ETWS) server through a mobile communication protocol.

15. The electronic device of claim 10, wherein, if the at least one the set power saving scheme is a network limiting scheme for limiting transmission of information based on a network, a call processor (CP) is configured to perform at least one of an operation of fixing a network function (NAT) in order to increase a sleep period of a if a screen is turned off, an operation of filtering the information received from a network to prevent the information from being transmitted to an application processor (AP) if the screen is turned off, and if a route table is deleted to block mobile data transmission/reception between the AP and the CP if the screen is turned off and then subsequently turned on, reconstructing the route table.
